(19) United States
(12) Patent Application Publication
(10) Pub. No.: US 2024/0251200 A1
(43) Pub. Date: Jul. 25, 2024

(54) ACOUSTIC OUTPUT DEVICES

(71) Applicant: SHENZHEN SHOKZ CO., LTD., Shenzhen (CN)

(72) Inventors: Liwei WANG, Shenzhen (CN); Lei ZHANG, Shenzhen (CN)

(73) Assignee: SHENZHEN SHOKZ CO., LTD., Shenzhen (CN)

(21) Appl. No.: 18/432,210

(22) Filed: Feb. 5, 2024

Related U.S. Application Data
(63) Continuation of application No. PCT/CN2022/078033, filed on Feb. 25, 2022.

(51) Int. Cl. H04R 1/32; H04R 1/28; H04R 7/06; H04R 9/02; H04R 17/00

(52) U.S. Cl. CPC H04R 1/323; H04R 1/2869; H04R 7/06; H04R 9/025; H04R 17/005; H04R 2201/401

(57) ABSTRACT

The present disclosure provides an acoustic output device. The acoustic output device includes a first acoustic assembly and a second acoustic assembly. The first acoustic assembly may comprise a first diaphragm, and the first diaphragm vibrates to produce a first sound. The second acoustic assembly may comprise a second diaphragm, the second diaphragm vibrates to produce a second sound, wherein at least a portion of the second diaphragm may be disposed around the first diaphragm. Vibrational phases of the first diaphragm and the second diaphragm may be opposite in a target frequency range, and the second sound may interfere with the first sound to produce a directional acoustic field pointing to a target direction.

### CROSS-REFERENCE TO RELATED APPLICATION

This application is a continuation of International Application No. PCT/CN2022/078033, filed on Feb. 25, 2022, the entire contents of which are hereby incorporated by reference.

### TECHNICAL FIELD

The present disclosure relates to the field of acoustics, and in particular, to an acoustic output device.

### BACKGROUND

A conventional audio device exhibits monopole radiation at a relatively low frequency. The monopole radiation ensures a high radiation efficiency, but may result in insufficient focus of acoustic energy, thereby leading to a relatively large far-field sound leakage. Therefore, in order to meet the increasingly important requirement of directional audio devices, it is necessary to adjust the directivity of the sound source in the far-field while maintaining near-field radiation efficiency. Currently, an open audio device often includes holes corresponding to the front and back cavities to create a quasi-dipole configuration. The radiation mechanism of the quasi-dipole is used to control the direction of sound radiation, thereby ensuring efficient radiation. However, inconsistencies in dimensions of the holes and inconsistencies in front and rear radiations of a speaker in an actual product would diminish radiation efficiency. Moreover, the presence of holes in the audio device may also compromise the reliability of the product, particularly its waterproofing performance.

Therefore, it is desired to provide an acoustic output device in which the directivity of a sound source can be controlled to improve the sound direction of the acoustic output device.

### SUMMARY

One of the embodiments of the present disclosure provides an acoustic output device. The acoustic output device may include a first acoustic assembly and a second acoustic assembly. The first acoustic assembly may comprise a first diaphragm, and the first diaphragm may be configured to vibrate to produce a first sound. The second acoustic assembly may comprise a second diaphragm, and the second diaphragm may be configured to vibrate to produce a second sound, wherein at least a portion of the second diaphragm may be disposed around the first diaphragm. In a target frequency range, a vibration phase of the first diaphragm may be opposite to a vibration phase of the second diaphragm, and the second sound may interfere with the first sound to produce a directional acoustic field pointing to a target direction.

In some embodiments, a ratio between a vibration amplitude of the first diaphragm and a vibration amplitude of the second diaphragm may be in a range of 0.8-1.2.

The second acoustic assembly may comprise a second diaphragm, and the second diaphragm may be configured to vibrate to produce a second sound, wherein at least a portion of the second diaphragm may be disposed around the first diaphragm.

In some embodiments, the first diaphragm and the second diaphragm may be disposed side-by-side, and a vibration direction of the second diaphragm may be parallel to a vibration direction of the first diaphragm.

In some embodiments, a ratio between an outer diameter of the second diaphragm and a diameter of the first diaphragm may be not less than 2.

In some embodiments, a ratio between an annular width of the second diaphragm and a radius of the first diaphragm may be not less than 2.

In some embodiments, a ratio between an area of the second diaphragm and an area of the first diaphragm may be not less than 4.

In some embodiments, the second diaphragm may be disposed obliquely relative to the first diaphragm, and an angle between the vibration direction of the second diaphragm and the vibration direction of the first diaphragm may be in a range of 0° to 45°.

In some embodiments, along the vibration direction of the first diaphragm, an outer edge of the second diaphragm may be farther away from the first diaphragm than an inner edge of the second diaphragm.

In some embodiments, a ratio between an area of the second diaphragm and an area of the first diaphragm may be not less than 1.

In some embodiments, a ratio between an outer diameter of the second diaphragm and a diameter of the first diaphragm may be not less than 1.

In some embodiments, the acoustic output device of claim 1 may further comprise a filtering processing assembly, the filtering processing assembly may be configured to generate a first audio signal by performing a filtering processing on an audio signal, and determine a phase-modulated first audio signal by performing a phase-modulation processing on the first audio signal, wherein the first diaphragm may generate the first sound based on the audio signal, and the second diaphragm may generate the second sound based on the phase-modulated first audio signal.

In some embodiments, the acoustic output device may further comprise a frequency-dividing processing assembly, the frequency-dividing processing assembly may be configured to generate a second audio signal and a third audio signal by dividing an audio signal, and determine a phase-modulated third audio signal by performing a phase-modulation processing on the third audio signal.

In some embodiments, the third audio signal and the phase-modulated third audio signal may be opposite in phase.

In some embodiments, the frequency-dividing processing assembly may be configured to generate the second audio signal and the third audio signal by dividing, based on a frequency-dividing point, the audio signal.

In some embodiments, a frequency range of the audio signal may be in a range of 20 Hz to 20 kHz and a frequency range of the frequency-dividing point may be in a range of 200 Hz to 1000 Hz.

In some embodiments, the frequency-dividing processing assembly may be further configured to determine a fourth audio signal based on the second audio signal and the phase-modulated third audio signal, wherein the first diaphragm may generate the first sound based on the audio signal and the second diaphragm may generate the second sound based on the fourth audio signal.

In some embodiments, the acoustic output device may further comprise a housing for accommodating the first acoustic assembly and the second acoustic assembly, wherein the housing may comprise a sound guiding hole configured to guide a third sound generated by the first diaphragm or the second diaphragm out of the housing, and the third sound may be opposite in phase to the first sound or the second sound.

In some embodiments, the first diaphragm may generate the first sound based on the third audio signal and the second diaphragm may generate the second sound based on the phase-modulated third audio signal.

In some embodiments, the acoustic output device may further comprise a second acoustic output device, wherein the second acoustic output device may include a third acoustic assembly, comprising a third diaphragm configured to generate a fourth sound based on the second audio signal.

In some embodiments, the acoustic output device may further comprise a housing for accommodating the third acoustic assembly, wherein the housing may comprise a sound guiding hole configured to guide a fifth sound generated by the third diaphragm out of the housing, and the fifth sound and the fourth sound may be opposite in phase.

In some embodiments, the acoustic output device may comprise a magnetic circuit assembly, configured to provide a first magnetic gap and a second magnetic gap, and a direction of a magnetic field in the first magnetic gap is opposite to a direction of a magnetic field in the second magnetic gap; and a voice coil assembly, comprising a first voice coil and a second voice coil, wherein one end of the first voice coil may be disposed within the first magnetic gap, and the other end of the first voice coil may be connected to the first diaphragm; and one end of the second voice coil may be disposed within the second magnetic gap, and the other end of the second voice coil may be connected to the second diaphragm.

In some embodiments, the acoustic output device may include a first magnetic circuit assembly and a second magnetic circuit assembly. The first magnetic circuit assembly may comprise a plurality of sets of first magnets, each set of first magnets comprising two first magnets with opposite magnetization directions, wherein the two first magnets are disposed facing each other on two sides of the first diaphragm. The second magnetic circuit assembly may comprise a plurality of sets of second magnets, each set of second magnets comprising two second magnets with opposite magnetization directions, wherein the two second magnets are disposed facing each other on two sides of the second diaphragm.

In some embodiments, the acoustic output device may further comprise a first wire disposed within the first diaphragm and a second wire disposed within the second diaphragm, wherein the first wire may be disposed between two adjacent first magnets of the plurality of sets of first magnets and the second wire may be disposed between two adjacent second magnets of the plurality of sets of second magnets.

In some embodiments, the first wire and the second wire disposed in a same direction of a magnetic field may be opposite in current direction.

In some embodiments, the acoustic output device may comprise a piezoelectric assembly and a vibration transmission assembly. The piezoelectric assembly may be configured to convert a voltage signal into a mechanical vibration, comprising a first piezoelectric element and a second piezoelectric element. The vibration transmission assembly may comprise a vibration transmission assembly, comprising a first vibration transmission element and a second vibration transmission element, wherein the first vibration transmission element may be configured to connect the first piezoelectric element and the first diaphragm to transmit the mechanical vibration; and the second vibration transmission element may be configured to connect the second piezoelectric element and the second diaphragm to transmit the mechanical vibration.

In some embodiments, the first piezoelectric element and the second piezoelectric element may be opposite in polarization direction.

In some embodiments, the first piezoelectric element and the second piezoelectric element may have opposite electrodes.

In some embodiments, piezoelectric signals acting on the first piezoelectric element and the second piezoelectric element may be opposite in phase.

In some embodiments, the acoustic output device may include a first magnetic circuit and a second magnetic circuit. The first magnetic circuit may comprise a first driving unit, wherein the first driving unit may comprise a first voice coil configured to cause the first diaphragm to vibrate by changing, based on an electrical signal, a magnetic flux density in the first magnetic circuit. The second magnetic circuit may comprise a second driving unit, wherein the second driving unit may comprise a second voice coil configured to cause the second diaphragm to vibrate by changing, based on the electrical signal, a magnetic flux density in the second magnetic circuit.

In some embodiments, winding directions of the first voice coil and the second voice coil may be opposite.

In some embodiments, magnetic circuit directions of the first magnetic circuit and the second magnetic circuit may be opposite.

In some embodiments, an electrical signal in the first voice coil and an electrical signal in the second voice coil may be opposite in phase.

One embodiment of the present disclosure provides an acoustic output system. The acoustic output system may comprise a first loudspeaker array configured to generate a first sound; and a second loudspeaker array configured to generate a second sound, wherein at least a portion of the second loudspeaker array may be disposed around the first loudspeaker array; and in a target frequency range, the first sound and the second sound may be opposite in phase, and the second sound may interfere with the first sound to produce a directional acoustic field pointing to a target direction.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary application scenario of an acoustic output device according to some embodiments of the present disclosure;

FIG. 2A is a schematic diagram illustrating an exemplary structure of a Helmholtz resonator according to some embodiments of the present disclosure;

FIG. 2B is a schematic diagram illustrating an exemplary Helmholtz resonator array according to some embodiments of the present disclosure;

FIG. 3A is a schematic diagram illustrating an exemplary cross-sectional view of an acoustic field distribution when a Helmholtz resonator array is disposed around a sound source according to some embodiments of the present disclosure;

FIG. 3B is a schematic diagram illustrating an exemplary cross-sectional view of an acoustic field distribution when a Helmholtz resonator array is not disposed around a sound source according to some embodiments of the present disclosure;

FIG. 4A is a schematic diagram illustrating an exemplary cross-sectional view of an acoustic field distribution when a count of Helmholtz resonators is 6 according to some embodiments of the present disclosure;

FIG. 4B is a schematic diagram illustrating an exemplary cross-sectional view of an acoustic field distribution when a count of Helmholtz resonators is 10 according to some embodiments of the present disclosure;

FIG. 5A is a schematic diagram illustrating an exemplary cross-sectional view of an acoustic field distribution when a Helmholtz resonator array has a cycle length according to some embodiments of the present disclosure;

FIG. 5B is a schematic diagram illustrating an exemplary cross-sectional view of an acoustic field distribution when a Helmholtz resonator array has a cycle length different from a cycle length illustrated in FIG. 5A according to some embodiments of the present disclosure;

FIG. 6 is a schematic diagram illustrating an exemplary cross-sectional view of an acoustic field distribution when impedance boundaries have different pinch angles according to some embodiments of the present disclosure;

FIG. 7 is a schematic diagram illustrating an exemplary structure of an annular diaphragm according to some embodiments of the present disclosure;

FIG. 8 is a schematic diagram illustrating an exemplary radiation effect after a second diaphragm adjusts an acoustic field formed by a first diaphragm according to some embodiments of the present disclosure;

FIG. 9 is a schematic diagram illustrating an exemplary cross-sectional view of an acoustic field distribution when vibrational directions of the first diaphragm and the second diaphragm have different angles according to some embodiments of the present disclosure;

FIG. 10 is a block diagram illustrating an exemplary acoustic output device according to some embodiments of the present disclosure;

FIG. 11 is a schematic diagram illustrating an exemplary principle of a filtering control according to some embodiments of the present disclosure;

FIG. 12 is a schematic diagram illustrating an exemplary principle of a frequency-dividing control according to some embodiments of the present disclosure;

FIG. 13 is a schematic diagram illustrating another principle of a frequency-dividing control according to some embodiments of the present disclosure;

FIG. 14 is a schematic diagram illustrating an exemplary structure of an acoustic output device according to some embodiments of the present disclosure;

FIGS. 15A to 15D are schematic diagrams illustrating exemplary structures of acoustic output devices according to some embodiments of the present disclosure;

FIGS. 15E to 15F are schematic diagrams illustrating exemplary structures of acoustic output devices according to some embodiments of the present disclosure;

FIG. 15G is a schematic diagram illustrating an exemplary structure of an acoustic output device according to some embodiments of the present disclosure;

FIG. 16 is a schematic diagram illustrating an exemplary structure of an acoustic output device according to some other embodiments of the present disclosure;

FIG. 17 is a schematic diagram illustrating an exemplary structure of an acoustic output device according to some other embodiments of the present disclosure;

FIG. 18A is a schematic diagram illustrating an exemplary structure of an acoustic output device according to some other embodiments of the present disclosure;

FIG. 18B to 18C are schematic diagrams illustrating exemplary structures of acoustic output devices according to some embodiments of the present disclosure;

FIG. 18D is a schematic diagram illustrating an exemplary structure of an acoustic output device according to some embodiments of the present disclosure;

FIG. 18E is a schematic diagram illustrating an exemplary structure of an acoustic output device according to some embodiments of the present disclosure;

FIG. 19 is a schematic diagram illustrating an exemplary structure of an acoustic output device according to some other embodiments of the present disclosure;

FIG. 20A is a schematic diagram illustrating an exemplary structure of an acoustic output device according to some embodiments of the present disclosure;

FIG. 20B is a schematic diagram illustrating an exemplary structure of an acoustic output device according to some embodiments of the present disclosure;

FIG. 20C is a schematic diagram illustrating an exemplary structure of an acoustic output device according to some embodiments of the present disclosure;

FIG. 21 is a schematic diagram illustrating an exemplary structure of a speaker according to some embodiments of the present disclosure;

FIGS. 22A to 22D are schematic diagrams illustrating exemplary structures of different driving modes of an acoustic output device for a speaker according to some embodiments of the present disclosure;

FIG. 23A is a schematic diagram illustrating an exemplary structure of a loudspeaker array according to some other embodiments of the present disclosure;

FIG. 23B is a schematic diagram illustrating an exemplary structure of a loudspeaker array according to some embodiments of the present disclosure;

FIG. 23C is a schematic diagram illustrating an exemplary structure of a loudspeaker array according to some other embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios following these drawings without creative labor. Unless obviously obtained from the context or the context illustrates otherwise, the same numeral in the drawings refers to the same structure or operation.

It should be understood that the terms “system”, “device”, “unit” and/or “module” as used herein are a way to distinguish between different components, elements, parts, sections, or assemblies at different levels. However, the words may be replaced by other expressions if other words accomplish the same purpose.

As shown in the present disclosure and the claims, unless the context suggests an exception, the words “one,” “an”, “a”, “one kind”, and/or “the” do not refer specifically to the singular, but may also include the plural. Generally, the terms “including” and “comprising” suggest only the inclusion of clearly identified steps and elements that do not constitute an exclusive list, and the method or apparatus may also include other steps or elements.

Flowcharts are used in the present disclosure to illustrate operations performed by a system according to embodiments of the present disclosure. It should be appreciated that the preceding or following operations are not necessarily performed in an exact sequence. Instead, steps can be processed in reverse order or simultaneously. Also, it is possible to add other operations to these processes, or to remove a step or steps from these processes.

Embodiments of the present disclosure provide an acoustic output device. The acoustic output device may include a first acoustic assembly and a second acoustic assembly. The first acoustic assembly may include a first diaphragm, and the first diaphragm may produce a first sound. The second acoustic assembly may include a second diaphragm, and the second diaphragm may produce a second sound. In some embodiments, at least a portion of the second diaphragm may be disposed around the first diaphragm. For example, the first diaphragm may be a circular diaphragm, and the second diaphragm may be an annular diaphragm disposed around the circular diaphragm. In some embodiments, in a target frequency range, a vibration phase of the first diaphragm may be opposite to a vibration phase of the second diaphragm, and the second sound may interfere with the first sound to produce a directional acoustic field pointing to a target direction. In some embodiments, the target frequency range may be a frequency range of an audio signal output by the acoustic output device. For example, the target frequency range may be a low frequency range (e.g., 20 Hz-500 Hz), a medium-to-high frequency range (e.g., 500 Hz-9000 Hz), etc.

In some embodiments, the directional acoustic field pointing to the target direction may also be constructed by adjusting a boundary impedance of the acoustic output device. In some embodiments, the boundary impedance of the acoustic output device may be adjusted by utilizing a Helmholtz resonator or an array thereof. For example, the Helmholtz resonator or an array thereof may be provided at a boundary of a sound outlet/acoustic radiation surface of the acoustic output device. The Helmholtz resonator or array thereof may absorb a sound generated by the acoustic output device and resonate to produce another sound. Based on a relationship between a frequency of a sound source and a resonance frequency of the Helmholtz resonator, the Helmholtz resonator or the array thereof may be adjusted, for example, structural parameters of the Helmholtz resonator and parameters related to an array distribution, etc., may be adjusted such that a vibration phase of a sound generated by a resonance of the Helmholtz resonator or the array thereof and a vibration phase of a sound generated by the acoustic output device may satisfy a specific relationship, which realizes different boundary impedance effects, thereby constructing the directional acoustic field pointing to the target direction.

The acoustic output device provided by the embodiments of the present disclosure may set a structural relationship between the first diaphragm and the second diaphragm and make a vibration phase of the first diaphragm and a vibration phase of the second diaphragm satisfy a specific relationship such that the second sound may interfere with the first sound, thereby generating a directional acoustic field pointing to the target direction and improving a directivity of the acoustic output device while ensuring a radiation efficiency of the acoustic output device. The acoustic output device provided in embodiments of the present disclosure may also utilize the Helmholtz resonator or an array thereof to adjust the boundary impedance of the acoustic output device, thereby constructing the directional acoustic field pointing to the target direction and improving the directivity of the acoustic output device.

FIG. 1 is a schematic diagram illustrating an exemplary application scenario of an acoustic output device according to some embodiments of the present disclosure.

An acoustic output device 110 may be a device with a capability of outputting a sound. The acoustic output device 110 may convert an audio signal (e.g., an electrical signal) into a mechanical vibration signal and output the mechanical vibration signal to an outside world in the form of sound. In some embodiments, a relative position of the acoustic output device 110 to a user may be different in different application scenarios when the user uses the acoustic output device 110. The user usually desires that a sound output by the acoustic output device 110 may be directed to an ear 120 of the user. It can also be understood that when the relative position of the acoustic output device 110 to the ear 120 of the user is determined, the acoustic output device 110 may output a sound that is directed to the ear 120 of the user. In such cases, the acoustic output device 110 ma be made to output the sound directed to the ear 120 of the user by constructing a directional acoustic field with a directivity.

In some embodiments, the acoustic output device 110 may be applied to an electronic device such as a headset, a hearing aid, a mobile device, a wearable device, a speaker, or the like. In some embodiments, the mobile device may include a cellular phone, a rechargeable smart home device, a rechargeable smart mobile device, a rechargeable virtual reality device, a rechargeable augmented reality device, or the like, or any combination thereof. In some embodiments, the rechargeable smart home device may include a control device for a smart appliance, a smart monitoring device, a smart TV, a smart camera, etc., or any combination thereof. In some embodiments, the rechargeable smart mobile device may include a smart phone, a personal digital assistant (PDA), a gaming device, a navigation device, a POS device, etc., or any combination thereof. In some embodiments, the rechargeable virtual reality device and/or the rechargeable augmented reality device may include a virtual reality headset, virtual reality glasses, a virtual reality eye mask, an augmented reality headset, augmented reality glasses, an augmented Reality Eyepiece, etc., or any combination thereof.

Taking the acoustic output device 110 being applied to an open headset as an example, in some embodiments, the acoustic output device 110 may be fixed near the ear 120 of the user utilizing a fixing device 130 (e.g., an ear hook, a headband, etc.). The acoustic output device 110 may include a first acoustic assembly for generating a first sound and a second acoustic assembly for generating a second sound. A phase of the first sound is made to be opposite to a phase of the second sound by setting an acoustic structure (e.g., a driving assembly, a magnetic circuit assembly, etc.) of the acoustic output device 110. The first sound interferes with the second sound, and the second sound modulates the first sound, thereby constructing a directional acoustic field of the acoustic output device 110 such that the acoustic output device 110 outputs the sound directed to the ear 120 of the user.

In some embodiments, the acoustic output device may output the sound to the outside world through a sound outlet/acoustic radiation surface. When the acoustic output device has only one sound outlet/acoustic radiation surface that outputs the sound, the acoustic output device may be considered as a monopole sound source, and a sound pressure of an acoustic field generated by the monopole sound source may be expressed by an Equation (1):

$$p = \frac{j ω {ρ}_{0}}{4 π r} {Q}_{0} exp j ( ω t - k r ) \qquad ( 1 )$$

where p denotes the sound pressure, ρ₀ denotes an air density, ω denotes an angle frequency, r denotes a distance between a spatial position and a sound source, Q₀ denotes a sound source volume velocity, and k denotes a wave number. According to Equation (1), it can be seen that at a certain spatial position, a magnitude of the sound pressure is inversely proportional to a distance from the spatial position to the sound source.

In some embodiments, an acoustic field distribution of a radiation of the monopole sound source may be represented by a Green's function integral, and a Green's function of the monopole sound source in a two-dimensional infinite space may be represented by an Equation (2):

$$G ( x , y ) = \frac{i}{4 π} {\int }_{- ∞}^{∞} \frac{{e}^{i ( {k}_{x} x + {k}_{y} \vert y \vert )}}{{k}_{y}} {dk}_{x} \qquad ( 2 )$$

where, kₓ denotes a wave number along an x-direction and k_{y} denotes a wave number along a y-direction.

In some embodiments, the Green's function changes when the monopole sound source is near an impedance boundary. For example, when the monopole sound source is located at an origin coordinate of a two-dimensional coordinate system, the Green's function in the presence of a boundary impedance may be expressed as an Equation (3):

$$G ( x , y ) = \frac{i}{4 π} {\int }_{- ∞}^{∞} \frac{2 {k}_{y} {Z}_{s}^{′}}{{k}_{y} {Z}_{s}^{′} + ωρ} \frac{{e}^{i ( {k}_{x} x + {k}_{y} \vert y \vert )}}{{k}_{y}} {dk}_{x} \qquad ( 3 )$$

where, ρ denotes a propagation medium density and Zₛ^{⋅} denotes the boundary impedance. Comparing the Green's function Equation (2) of the monopole sound source in the two-dimensional infinite space, it can be seen that there is one more coefficient

$$\frac{2 {k}_{y} {Z}_{s}^{′}}{{k}_{y} {Z}_{s}^{′} + ωρ}$$

in Equation (3) than in Equation (2), which can be referred to as a tailoring factor. Accordingly, the monopole sound source in different boundary impedance conditions may produce different tailoring factors, and the acoustic field radiation of the monopole sound source may also present a different state, so as to produce different acoustic radiation directivities. Therefore, the directivity of the radiation of the monopole sound source may be adjusted by adjusting the boundary impedance of the monopole sound source. In some embodiments, when the boundary impedance is approximated to be 0, a radiation acoustic field of the monopole sound source may be approximated regarded as a radiation acoustic field of a quasi-dipole.

In some embodiments, a Helmholtz resonator or an array thereof may be utilized to adjust the boundary impedance of the sound source. In some embodiments, a Helmholtz resonator array may be arrayed at a boundary of the sound source, the boundary impedance of the sound source may have an equivalent boundary impedance, and the equivalent boundary impedance may be expressed as an Equation (4):

$${Z}_{s}^{′} = i ( \frac{1}{ω {C}_{α}} - ω {M}_{a} ) d , \qquad ( 4 )$$

where Zₛ′ denotes an equivalent boundary impedance, Mₐ denotes an equivalent acoustic mass of the Helmholtz resonator, and Cₐ denotes an equivalent acoustic capacity of the Helmholtz resonator. The equivalent sound mass Mₐ and the equivalent sound capacity Cₐ are related to structural parameters (e.g., structural parameters of a neck, structural parameters of a cavity) of the Helmholtz resonator. A resonance frequency of the Helmholtz resonator may be expressed in an Equation (5):

$${f}_{0} = \frac{1}{2 π} \sqrt{\frac{1}{{M}_{a} {C}_{a}}} , \qquad ( 5 )$$

according to Equation (4) and Equation (5), the equivalent boundary impedance of the sound source may be expressed as:

$${Z}_{s}^{′} = i \cdot \frac{1 - {( \frac{f}{{f}_{0}} )}^{2}}{ω {C}_{a}} \cdot d , \qquad ( 6 )$$

where,

$$f = \frac{ω}{2 π}$$

denotes a frequency of the sound source.

According to Equation (6), when a relationship between the frequency of the sound source and the resonance frequency of the Helmholtz resonator is different, the equivalent boundary impedance of a point sound source is different, resulting in different tailoring factors for the point sound source, which makes the modulation effect of the radiation of a sound source at a position of the origin coordinate different. For example, in some embodiments, the equivalent boundary impedance may be a positive imaginary number when the frequency of the sound source is lower than the resonant frequency of the Helmholtz resonator. The equivalent boundary impedance may be a negative imaginary number when the frequency of the sound source is higher than the resonance frequency of the Helmholtz resonator; and when the frequency of the sound source is equal to the resonance frequency of the Helmholtz resonator, the equivalent boundary impedance may be 0.

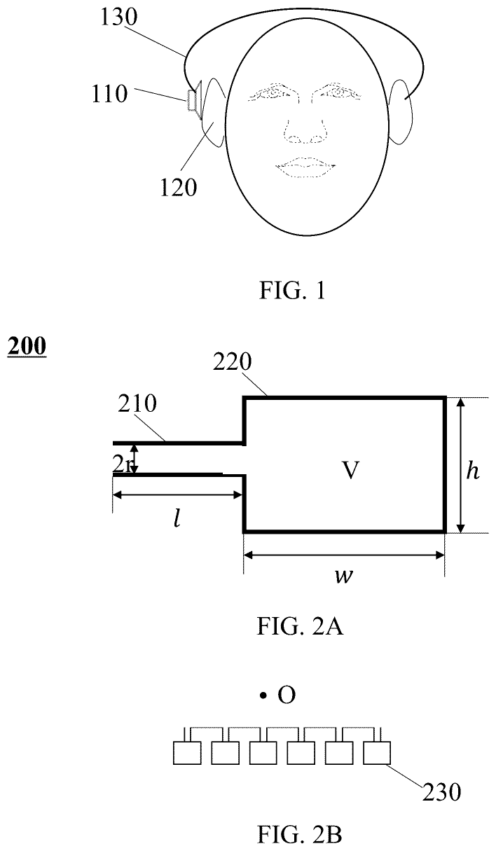

FIG. 2A is a schematic diagram illustrating an exemplary structure of a Helmholtz resonator according to some embodiments of the present disclosure. FIG. 2B is a schematic diagram illustrating an exemplary Helmholtz resonator array according to some embodiments of the present disclosure.

Referring to FIG. 2A, a Helmholtz resonator 200 may include a neck 210 and a cavity 220. The neck 210 is acoustically connected to the cavity 220, and the cavity 220 is connected to an outside world through the neck 210. In some embodiments, the neck 210 may be a pipeline structure, with one end of the pipeline structure being connected to the cavity 220 and the other end of the pipeline structure being connected to the outside world. The cavity 220 may be a cavity structure, and a shape of the cavity structure may be a regular geometric shape such as a circle, rectangle, or the like, or an irregular shape. In some embodiments, the Helmholtz resonator 200 may cause air in the cavity 220 and/or the neck 210 to resonate by absorbing a sound from an environment (e.g., a sound output from a sound source described in the present disclosure), thereby producing a sound. In some embodiments, the sound produced by a resonance of the Helmholtz resonator 200 may and the sound that the Helmholtz resonator absorbs may be opposite in phase. In some embodiments, the sound produced by the resonance of the Helmholtz resonator 200 may be of the same or similar amplitude as the sound that the Helmholtz resonator absorbs. In this way, the sound produced by the resonance of the Helmholtz resonator 200 may interfere with the sound in the environment to create a directional acoustic field. In some embodiments, by adjusting structural parameters of the Helmholtz resonator 200 (the neck 210, the cavity 220), parameters associated with the resonance of the Helmholtz resonator 200 may be adjusted. The parameters associated with the resonance of the Helmholtz resonator 200 may include, but are not limited to, an equivalent sound mass, an equivalent sound capacity, a resonance frequency, or the like. Structural parameters of the Helmholtz resonator may include but are not limited to, a radius r of the neck, a length l of the neck, a cross-sectional area of the neck, a volume V of the cavity, a length w of the cavity, a width h of the cavity, etc.

Referring to FIG. 2B, the Helmholtz resonators 200 shown in FIG. 2A may form a Helmholtz resonator array 230. In some embodiments, the Helmholtz resonator array 230 may be disposed around a sound source O. For example, the Helmholtz resonator array 230 may be disposed at one side of the sound source O and arranged along a circumference of the sound source O. The Helmholtz resonator array 230 may absorb a sound generated by the sound source O and resonate with the sound generated by the sound source O to produce a sound. The sound generated by the Helmholtz resonator array 230 and the sound generated by the sound source O may satisfy a specific relationship (e.g., opposite in phase, same or similar in amplitude, etc.), thereby constructing the directional acoustic field.

In some embodiments, when the Helmholtz resonator 200 or an array thereof is disposed at a boundary of a sound source, by adjusting structural parameters of the neck 210 and the cavity 220 of the Helmholtz resonator 200 or parameters related to a distribution of the array thereof, a resonance frequency of the Helmholtz resonator 200 or the array thereof may be adjusted, which may adjust an equivalent boundary impedance of the sound source, and thereby controlling an acoustic field radiation of the sound source. For example, to adjust an acoustic field distribution of a sound with a frequency of about 8000 Hz to construct a directional acoustic field in the frequency range, the structural parameters of the neck 210 and the cavity 220 of the Helmholtz resonator 200 may be set to make the resonance frequency of the Helmholtz resonator 200 be about 8000 Hz. At this time, the equivalent boundary impedance of the sound source may be close to 0, so that a directional acoustic field with a frequency of about 8000 Hz may be constructed. In some embodiments, the structural parameters of the Helmholtz resonator may affect a radiation frequency and bandwidth of the directional acoustic field that the Helmholtz resonator forms. For example, when a radiation frequency of the sound source is equal to (or close to) the resonance frequency of the Helmholtz resonator, the Helmholtz resonator may resonate to construct the directional acoustic field. In such cases, the structural parameters of the Helmholtz resonator may determine a radiation frequency corresponding to the directional acoustic field and, accordingly, a bandwidth corresponding to the directional acoustic field.

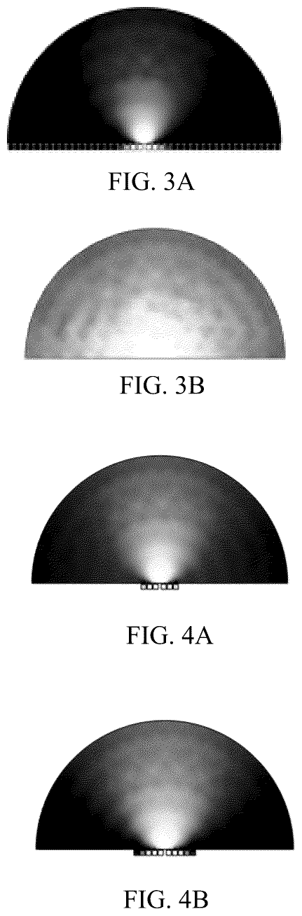

FIG. 3A is a schematic diagram illustrating a cross-sectional view of an acoustic field distribution when a Helmholtz resonator array is disposed around a sound source according to some embodiments of the present disclosure. FIG. 3B is a schematic diagram illustrating a cross-sectional view of an acoustic field distribution when a Helmholtz resonator array is not disposed around a sound source according to some embodiments of the present disclosure. For illustrative purposes only, for a single Helmholtz resonator in a Helmholtz resonator array illustrated in FIG. 3A, a length of a neck of the Helmholtz resonator is 1 mm, a radius of the neck is 0.5 mm, a length of a cavity of the Helmholtz resonator is 5 mm, a width of the cavity is 5 mm, and a resonance frequency of the Helmholtz resonator is 8000 Hz. According to FIG. 3A and FIG. 3B, the acoustic field radiation of the sound source has an obvious directivity when the Helmholtz resonator array is set at a boundary of the sound source.

In some embodiments, a count of Helmholtz resonators in the Helmholtz resonator array may affect the directivity of the acoustic field. For example, with a constant cycle length of the Helmholtz resonator array, as the count of Helmholtz resonators in the array decreases, the directivity of the acoustic field may be diminished. Here, the cycle length of the Helmholtz resonator is a distance between geometric centers of two adjacent Helmholtz resonators in the Helmholtz resonator array. FIG. 4A is a schematic diagram illustrating a cross-sectional view of an acoustic field distribution when a count of Helmholtz resonators is 6 according to some embodiments of the present disclosure. FIG. 4B is a schematic diagram illustrating a cross-sectional view of an acoustic field distribution when a count of Helmholtz resonators is 10 according to some embodiments of the present disclosure. It is to be appreciated that FIGS. 4A and 4B only illustrate a count of Helmholtz resonators in a cross-section where a sound source is located, and that a Helmholtz resonator array may be disposed around the sound source, and a total count of Helmholtz resonators in the array may be greater than or equal to the count of Helmholtz resonators in the cross-section. In conjunction with FIGS. 4A and 4B, when the count of Helmholtz resonators disposed around the sound source is 6 and 10, respectively, an acoustic field radiation of the sound source is directional, and a directivity when the count of Helmholtz resonators is 10 may be higher than a directivity when the count of Helmholtz resonators is 6. In some embodiments, the count of Helmholtz resonators may be determined based on a frequency and/or wavelength of a sound source to be adjusted. For example, with a constant cycle length of the Helmholtz resonator array, the count of Helmholtz resonators may be configured such that a length of the Helmholtz resonator array is close to, or twice of a wavelength of a sound source to be adjusted. For example, a frequency of the sound source to be adjusted is 8000 Hz, which corresponds to a wavelength of 4.28 cm. Correspondingly, the length of the Helmholtz resonator array may be greater than or equal to 8 cm. When the cycle length of the Helmholtz resonator is 8 mm, the count of Helmholtz resonators in the Helmholtz resonator array may be 10 or more. For example, 5 or more Helmholtz resonators may be disposed on a single side of the sound source, which may result in a better directivity of an acoustic field radiation of the sound source.

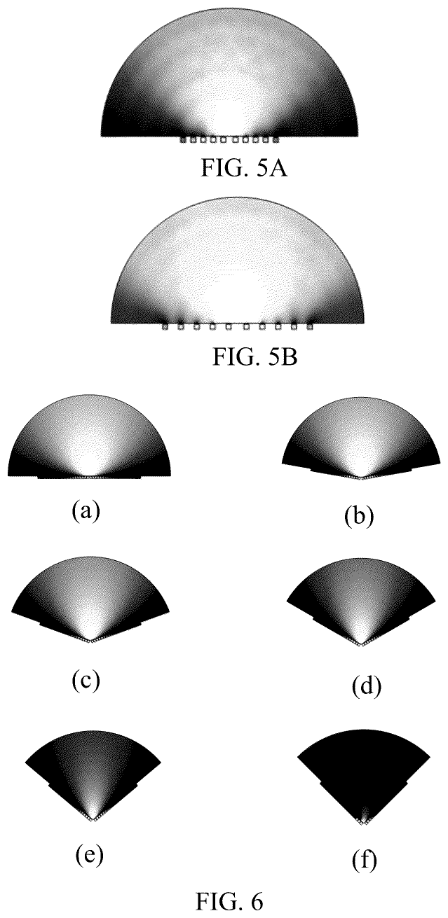

In some embodiments, the cycle length of the Helmholtz resonator in the Helmholtz resonator array may affect the directivity of the acoustic field. For example, with all other parameters (the count of Helmholtz resonators) being equal, an increase in the cycle length of the Helmholtz resonator results in a progressive decrease in the change rate of a tailoring factor and a progressively increase in an equivalent acoustic impedance rate. Correspondingly, the directivity of the acoustic field may diminish. FIG. 5A is a schematic diagram illustrating a cross-sectional view of an acoustic field distribution when a Helmholtz resonator array has a cycle length according to some embodiments of the present disclosure. FIG. 5B is a schematic diagram illustrating a cross-sectional view of an acoustic field distribution when a Helmholtz resonator array has a cycle length different from that in FIG. 5A according to some embodiments of the present disclosure. According to FIG. 5A and FIG. 5B, a cycle length of Helmholtz resonators in FIG. 5A is less than a cycle length of Helmholtz resonators in FIG. 5B, and a directivity effect of an acoustic field in FIG. 5A is better than the directivity effect of an acoustic field in FIG. 5B.

In some embodiments, the cycle length of the Helmholtz resonators may be set uniformly or non-uniformly. In some embodiments, structural parameters of the Helmholtz resonators may be the same or different in the same array.

In some embodiments, boundaries formed by the Helmholtz resonator array on two sides of the sound source may form an angle, and when the angle varies, the sound source is adjusted differently, resulting in a different radiation effect of a monopole sound source.

FIG. 6 is a schematic diagram illustrating a cross-sectional view of an acoustic field distribution when impedance boundaries have different angles according to some embodiments of the present disclosure.

Figures (a) to (f) in FIG. 6 denote acoustic field distributions in a cross-section when an angle between the boundaries formed by the Helmholtz resonator array on two sides of a sound source is 180°, 160°, 140°, 120°, 100°, and 90°, respectively. Combined with figures (a)-(f) in FIG. 6, the smaller the angle between the boundaries on the two sides of the sound source, the more directional the acoustic field of the sound source. In some embodiments, a radiation efficiency of the sound source may decrease as the angle between the boundaries on two sides of the sound source decreases. For example, as shown in figure (f) of FIG. 6, when the angle between the boundaries on two sides of the sound source is 90°, a distance between a secondary sound source formed by a neck of the Helmholtz resonator array and the sound source is too close, which may result in a sound short circuit, resulting in low radiation efficiency of the sound source. In some embodiments, to ensure the directivity of the sound source and the radiation efficiency of the sound source, the angle between the boundaries on two sides of the sound source may be 95° to 180°.

In some embodiments, an additional sound source (e.g., a circular sound source) may be provided around a central sound source (e.g., a circular sound source) and used to output a sound signal that is opposite to the central sound source in phase, thereby controlling an acoustic field radiation of the central sound source. In some embodiments, by controlling the acoustic field radiation of the central sound source through the additional sound source, the acoustic field radiation of the central sound source in a target frequency domain may be controlled. In some embodiments, the additional sound source is provided around the central sound source, which may control a radiation around the central sound source, while reducing the impact on a central radiation of the central sound source. In some embodiments, the central sound source may be of any shape. For example, the central sound source may have a regular shape such as a circle, a runway shape, a rectangle, a pentagon, or the like, or an irregular shape. At least a portion of the additional sound source may be a regular or irregular shape that surrounds the central sound source. For example, the central sound source may have a runway shape, and the additional sound source may be an annulus surrounding the runway-shaped sound source. As another example, the central sound source may have a circular shape, and the additional sound source may be a ring that surrounds the circular-shaped sound source.

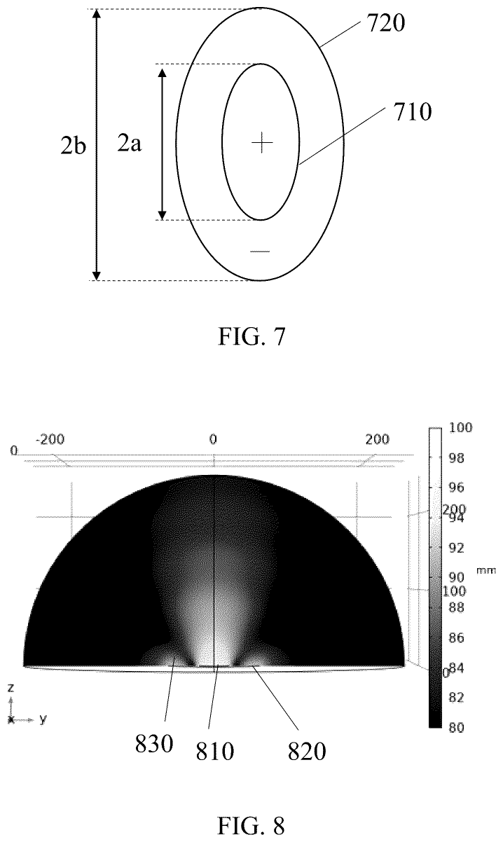

FIG. 7 is a schematic diagram illustrating an exemplary structure of an annular diaphragm according to some embodiments of the present disclosure.

Referring to FIG. 7, in some embodiments, a first diaphragm 710 may be considered as a central sound source, and a vibration of the first diaphragm 710 may produce a first sound. A second diaphragm 720 may be considered as an additional sound source, and a vibration of the second diaphragm 720 may produce a second sound. At least a portion of the second diaphragm 720 is disposed around the first diaphragm 710. In some embodiments, the first diaphragm 710 may have any shape. For example, the first diaphragm 710 may have a regular shape such as a circle, a runway shape, a rectangle, a pentagon, or the like, or an irregular shape. At least a portion of the second diaphragm 720 may have a regular or irregular shape that surrounds the first diaphragm 710. For example, as shown in FIG. 7, the first diaphragm 710 may be a circular diaphragm, and the second diaphragm 720 may be an annular diaphragm that disposes around the circular diaphragm. In some embodiments, a radius of the first diaphragm 710 may be a radius of the circular diaphragm, i.e., a radius a of the central sound source. A radius of the second diaphragm 720 may be a radius of the outer circumference of the circular diaphragm, i.e., a radius b of the additional sound source.

In some embodiments, the second sound may be made to be opposite in phase to the first sound by making a vibration phase of the first diaphragm 710 opposite to the vibration phase of the second diaphragm 720. For example, when the first diaphragm 710 and the second diaphragm 720 are provided in an acoustic output device, by setting an acoustic structure of the acoustic output device (e.g., a driving assembly, a magnetic circuit assembly, etc.), the first diaphragm 710 and the second diaphragm 720 may be opposite in vibration phase. The phase of the first sound is opposite to the phase of the second sound, and the first sound interferes with the second sound, thereby constructing a directional acoustic field of the acoustic output device. In some embodiments, a vibration amplitude of the first diaphragm 710 may be the same as or similar to a vibration amplitude of the second diaphragm 720, so that the first sound and the second sound may better interfere with each other. As a result, the additional sound source may adjust the central sound source to construct a directional acoustic field of an overall sound source.

In some embodiments, according to a principle of superposition, the overall sound source comprising the central sound source and the additional sound source may be considered as a superimposed sound source of multiple sound sources. For example, the central sound source may be noted as a first sound source, and the additional sound source may comprise a same-phase sound source that is of the same radius (e.g., the radius a) as the first sound source and in the same phase as the central sound source (denoted as a second sound source) and an opposite-phase sound source that is of a different radius (e.g., the radius b) than the central sound source and is opposite in phase to the central sound source (denoted as a third sound source). That is, the additional sound source may be equivalently a superposition of the second sound source and third sound source, and the overall sound source may be a superposition of the first, second, and third sound sources. Sound pressures of the first sound source, the second sound source, and the third sound source may be expressed in Equation (7), Equation (8), and Equation (9), respectively:

$${P}_{1} = j ω \frac{{ρ}_{0} {U}_{1} {a}^{2}}{2 r} [ \frac{2 {J}_{1} ( ka sin θ )}{ka sin θ} ] {e}^{j ( ω t - kr )} \qquad ( 7 )$$

$${P}_{2} = j ω \frac{{ρ}_{0} {U}_{2} {a}^{2}}{2 r} [ \frac{2 {J}_{1} ( ka sin θ )}{ka sin θ} ] {e}^{j ( ω t - kr )} \qquad ( 8 )$$

$${P}_{3} = j ω \frac{{ρ}_{0} {U}_{2} {b}^{2}}{2 r} [ \frac{2 {J}_{1} ( kb sin θ )}{kb sin θ} ] {e}^{j ( ω t - kr )} \qquad ( 9 )$$

where, P₁, P₂, and P₃ denote sound pressures of acoustic fields generated by the first sound source, the second sound source, and the third sound source, respectively, U₁, and U₂ denote acoustic volume velocities of the first sound source and the second/third sound source, respectively, r denotes a distance to a center of the first sound source, a denotes a radius of the first sound source/second sound source, and b denotes a radius of the third sound source. The overall sound source may be a superposition of the first sound source, the second sound source, and the third sound source, i.e., the overall sound source is noted as: P=P₁=P₂+P₃. According to Equations (7)-(9), a directivity function of the overall sound source radiating into a forward half-space may be calculated, which can be expressed by Equation (10):

$$D ( θ ) = \frac{\frac{2 ( {U}_{1} + {U}_{2} ) {a}^{2} {J}_{1} ( ka sin θ )}{ka sin θ} + \frac{2 {U}_{2} {b}^{2} {J}_{1} ( kb sin θ ) {e}^{2 j k r}}{kb sin θ}}{( {U}_{1} + {U}_{2} ) {a}^{2} + {U}_{2} {b}^{2} {e}^{2 j k r}} , \qquad ( 10 )$$

when dimensions (e.g., the radii) and acoustic volume velocities of the first sound source and the additional sound source (the equivalent superposition of the second sound source and the third sound source) are determined, acoustic directivity functions may be obtained for different distances at different frequencies.

FIG. 8 is a schematic diagram illustrating an exemplary radiation effect after a second diaphragm adjusts an acoustic field formed by a first diaphragm according to some embodiments of the present disclosure.

Referring to FIG. 8, by proving a second diaphragm 820 (or an additional sound source) outside the first diaphragm 810 (or a central sound source), the second diaphragm 820 may adjust the acoustic field formed by the first diaphragm 810, which improves a directivity of an acoustic field generated by the first diaphragm 810, and thereby constructing an acoustic field with good directivity. In some embodiments, in conjunction with the directivity function Equation (10) of an overall sound source, the larger the radius a of the first diaphragm 810 is, the lower the frequency at which the second diaphragm 820 modulates the first diaphragm. When a value of k×a is 1 and a value of k×b lies in a range of 3 to 4, a radiation with a good directivity is obtained. In some embodiments, when a value of a distance r between a spatial location where the second diaphragm 820 is located and the first diaphragm 810 is different, the directivity of the overall sound source is essentially unchanged, but a radiation map of the overall sound source may show a tiny side flap (e.g., a side flap 830 shown in FIG. 8). In some embodiments, to ensure that the second diaphragm 820 is effective in modulating the first diaphragm 810, a vibration amplitude of the second diaphragm 820 may be greater than or equal to a vibration amplitude of the first diaphragm 810.

In some embodiments, the second diaphragm (e.g., an annular sound source) may be disposed obliquely relative to the first diaphragm (e.g., a circular sound source), so that there is an angle between a vibration direction of the second diaphragm and a vibration direction of the first diaphragm. The second diaphragm has a different modulation effect on the first diaphragm when the angle is different.

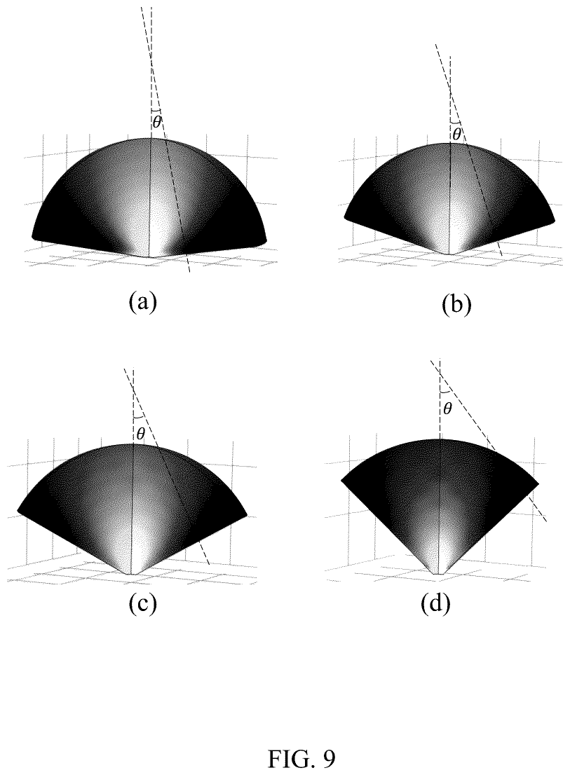

FIG. 9 is a schematic diagram illustrating a cross-sectional view of an acoustic field distribution when the vibration directions of a first diaphragm and a second diaphragm have different angles according to some embodiments of the present disclosure. In some embodiments, the vibration direction of the diaphragm may be parallel to the normal of a plane in which the diaphragm is located. Figures (a) to (d) in FIG. 9 indicate an acoustic field distribution of a sound source when an angle θ between the vibration direction of the second diaphragm and the vibration direction of the first diaphragm is 10°, 20°, 30°, and 45°, respectively. In some embodiments, the second diaphragm may be symmetrically distributed on two sides of the first diaphragm (e.g., along the vibration direction of the first diaphragm), as illustrated in a cross-section of the acoustic field distribution. According to figures (a)-(d) in FIG. 9, the greater the angle between the vibration direction of the second diaphragm and the vibration direction of the first diaphragm vibration, or the smaller the angle of the second diaphragm disposed on two sides of the first diaphragm, the greater the directivity of the sound source. For example, the angle between the vibration direction of the second diaphragm and the vibration direction of the first diaphragm may be 45° to ensure the directivity of the sound source. In some embodiments, when the vibration direction of the second diaphragm is parallel to the vibration direction of the first diaphragm, i.e., the second diaphragm is disposed side-by-side with the first diaphragm or the angle of the second diaphragm disposed on two sides of the first diaphragm is 180°, a ratio between a width of the second diaphragm and a width of the first diaphragm may be greater than or equal to a specific ratio, for example, 1:1, 1.5:1, 2:1, 3:1, or the like. Here, the width of the diaphragm refers to a dimension of the diaphragm in a direction perpendicular to the vibration direction of the diaphragm. Taking the second diaphragm being an annular diaphragm and the first diaphragm being a circular diaphragm as an example, the width of the first diaphragm refers to the radius of the circular diaphragm, and the width of the second diaphragm refers to an annular width of the annular diaphragm. For example, a ratio between the annular width of the annular diaphragm and the radius of the circular diaphragm may be greater than or equal to 2:1. In some embodiments, the greater the angle between the vibration direction of the second diaphragm and the vibration direction of the first diaphragm, or the smaller the angle of the second diaphragm disposed on two sides of the first diaphragm, the closer the second diaphragm to the first diaphragm, and the smaller the ratio between the width of the second diaphragm and the width of the first diaphragm. For example, when the ratio between the width of the second diaphragm and the width of the first diaphragm is less than or equal to 1:1, the angle between the vibration direction of the second diaphragm and the vibration direction of the first diaphragm may be greater than or equal to 67.5°. As another example, when the ratio between the width of the second diaphragm and the width of the first diaphragm is less than or equal to 2:1, the angle between the vibration direction of the second diaphragm and the vibration direction of the first diaphragm may be greater than or equal to 0°. This enables the radiation acoustic field of the sound source to have a strong directivity and also ensures that a far-field sound leakage of the radiation acoustic field is small, and a near-field radiation intensity is unchanged.

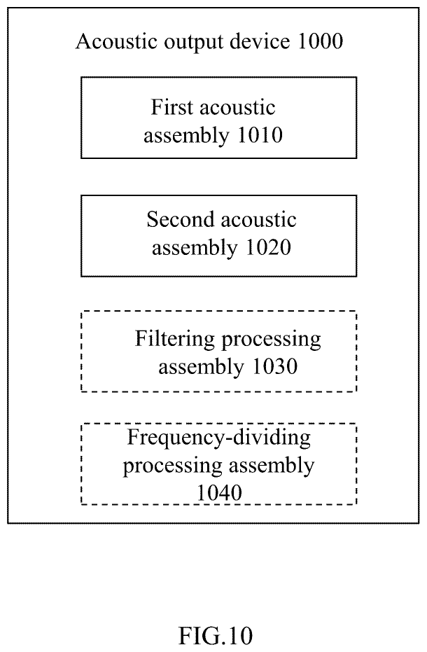

FIG. 10 is a block diagram illustrating an acoustic output device according to some embodiments of the present disclosure. Referring to FIG. 10, in some embodiments, the acoustic output device 1000 may include a first acoustic assembly 1010 and a second acoustic assembly 1020. The first acoustic assembly 1010 refers to an acoustic structure for generating a first sound. For example, the first acoustic assembly 1010 may generate the first sound by vibration. The second acoustic assembly 1020 refers to an acoustic structure for generating a second sound. For example, the second acoustic assembly 1020 may generate the second sound by vibration. In some embodiments, a vibration phase of the first acoustic assembly 1010 and a vibration phase of the second acoustic assembly 1020 may be opposite, so that a phase of the first sound is opposite to a phase of the second sound, and the first sound interferes with the second sound to produce a directional acoustic field pointing to a target direction. The target direction here is a predetermined direction. For example, when the acoustic output device is applied to an earphone, the target direction may be a direction in which the user's ear is located when wearing the earphone. In some embodiments, at least a portion of the second acoustic assembly 1020 may be disposed around the first acoustic assembly 1010. In some embodiments, the first acoustic assembly 1010 and the second acoustic assembly 1020 may be disposed side by side. In some embodiments, the second acoustic assembly 1020 may also be disposed obliquely relative to the first acoustic assembly 1010. In some embodiments, the directivity of the acoustic output device 1000 may be adjusted by setting a dimension (e.g., a diameter, an area, etc.) of the first acoustic assembly 1010 and the second acoustic assembly 1020.

In some embodiments, the first acoustic assembly 1010 may include a first diaphragm, and the first diaphragm may vibrate to produce the first sound. The second acoustic assembly 1020 may include a second diaphragm, and the second diaphragm may vibrate to produce the second sound. In some embodiments, the vibration phase of the first diaphragm and the vibration phase of the second diaphragm may be opposite or approximately opposite in a target frequency range, such that the phase of the first sound is opposite or approximately opposite to the phase of the second sound, thereby causing the first sound to interfere with the second sound to produce the directional acoustic field pointing to the target direction. For example, in a medium-to-high frequency range, the first sound interferes with the second sound in a far-field radiation range to produce the directional acoustic field pointing to the target direction. For example, the medium-to-high frequency may include a frequency band of 500 Hz-9000 Hz. It should be noted that a range of the above frequency bands may change with different industries, different application scenarios, and different classification criteria.

In some embodiments, a vibration amplitude of the first diaphragm and a vibration amplitude of the second diaphragm may be reasonably set to better control an acoustic field radiation of the acoustic output device 1000 and to improve the directivity of the acoustic output device 1000. In some embodiments, a ratio between the vibration amplitude of the first diaphragm and the vibration amplitude of the second diaphragm may be in a range of 0.5 to 2. In some embodiments, the ratio between the vibration amplitude of the first diaphragm and the vibration amplitude of the second diaphragm may be in a range of 0.6 to 1.5. In some embodiments, the ratio between the vibration amplitude of the first diaphragm and the vibration amplitude of the second diaphragm may be in a range of 0.8 to 1.2. For example, the ratio between the vibration amplitude of the second diaphragm and the vibration amplitude of the first diaphragm may be 1. In some embodiments, currents driving the first diaphragm and the second diaphragm may be set to control the acoustic field radiation of the acoustic output device 1000. For example, a ratio between a power of the current driving the first diaphragm and a power of the current driving the second diaphragm may be in a range of 0.1 to 5. As another example, the ratio between the power of the current driving the first diaphragm and the power of the current driving the second diaphragm may be in a range of 0.2 to 4. As another example, the ratio between the power of the current driving the first diaphragm and the power of the current driving the second diaphragm may be in a range of 0.3 to 3. As another example, the ratio between the power of the current driving the first diaphragm and the power of the current driving the second diaphragm may be in a range of 0.5 to 2.

In some embodiments, at least a portion of the second diaphragm may be disposed around the first diaphragm. In some embodiments, the first diaphragm may be a circular diaphragm, and the second diaphragm may be an annular diaphragm around the circular diaphragm. In some embodiments, the first diaphragm and the second diaphragm may be coaxially arranged. The first diaphragm and the second diaphragm being coaxially arranged refers to that a geometric center of the first diaphragm coincides or approximately coincides with a geometric center of the second diaphragm. The first diaphragm and the second diaphragm being coaxially arranged may facilitate modulation of the radiation of the acoustic output device 1000. In some embodiments, the first diaphragm and the second diaphragm may also be diaphragms with other shapes. For example, the first diaphragm may be a rectangular diaphragm, a pentagonal diaphragm, and other regular or irregular-shaped diaphragms, and the second diaphragm may be an annular diaphragm that is distributed around the rectangular diaphragm, a pentagonal diaphragm, and other regular or irregular shaped diaphragms.

In some embodiments, the first diaphragm and the second diaphragm may be disposed side-by-side, and a vibration direction of the second diaphragm is parallel to a vibration direction of the first diaphragm. When the first diaphragm and the second diaphragm are disposed side-by-side, at least a portion of the second diaphragm is located on the same plane as the first diaphragm. The first diaphragm and the second diaphragm disposed side-by-side may make a structure of the first diaphragm and the second diaphragm simpler, and at the same time facilitate control of a size of the first diaphragm and the second diaphragm.

In some embodiments, the sizes of the first diaphragm and the second diaphragm may be reasonably set to improve an output capability and the directivity of the acoustic output device 1000. In some embodiments, a ratio between an outer diameter of the second diaphragm and a diameter of the first diaphragm may be no less than 2. In some embodiments, the ratio between the outer diameter of the second diaphragm and the diameter of the first diaphragm may be no less than 1.5. In some embodiments, the ratio between the outer diameter of the second diaphragm and the diameter of the first diaphragm may be no less than 1. The outer diameter of the second diaphragm may be an outer diameter of the annular diaphragm, i.e., a diameter of an outer circumference of the annular diaphragm. In some embodiments, a ratio between an annular width of the second diaphragm and a radius of the first diaphragm may be no less than 2. In some embodiments, the ratio between the annular width of the second diaphragm and the radius of the first diaphragm may be no less than 1.5. In some embodiments, the ratio between the annular width of the second diaphragm and the radius of the first diaphragm may be no less than 1. In some embodiments, a ratio between an area of the second diaphragm and an area of the first diaphragm may be no less than 4. In some embodiments, the ratio between the area of the second diaphragm and the area of the first diaphragm may be no less than 3. In some embodiments, the ratio between the area of the second diaphragm and the area of the first diaphragm may be no less than 2.

In some embodiments, the second diaphragm may be disposed obliquely relative to the first diaphragm to further improve the directivity of the acoustic output device 1000 and to reduce the size of the acoustic output device 1000. In some embodiments, when the second diaphragm is disposed obliquely relative to the first diaphragm, an angle may be formed between the vibration direction of the second diaphragm and the vibration direction of the first diaphragm. In some embodiments, the angle between the vibration direction of the second diaphragm and the vibration direction of the first diaphragm may be in a range of 0° to 45°. For example, the angle between the vibration direction of the second diaphragm and the vibration direction of the first diaphragm may be 45°. As another example, the angle between the vibration direction of the second diaphragm and the vibration direction of the first diaphragm may be 30°. As a further example, the angle between the vibration direction of the second diaphragm and the vibration direction of the first diaphragm may be 20°. As a further example, the angle between the vibration direction of the second diaphragm and the vibration direction of the first diaphragm may be 10°.

In some embodiments, when the second diaphragm is disposed obliquely relative to the first diaphragm, an outer edge of the second diaphragm is located farther away from the first diaphragm than an inner edge of the second diaphragm along the vibration direction of the first diaphragm. That is, the second diaphragm is disposed on a different plane from the first diaphragm. The second diaphragm being disposed obliquely relative to the first diaphragm may further converge a sound beam and improve the directivity of the acoustic output device 1000. At the same time, an overall size of the acoustic output device 1000 may be reduced while ensuring that a size of the second diaphragm (e.g., an outer diameter, a width, an area, etc.).

In some embodiments, when the second diaphragm is disposed obliquely relative to the first diaphragm, the ratio between the area of the second diaphragm and the area of the first diaphragm may be not less than 1. In some embodiments, when the second diaphragm is disposed obliquely relative to the first diaphragm, the ratio between the area of the second diaphragm and the area of the first diaphragm may be no less than 0.8. In some embodiments, when the second diaphragm is disposed obliquely relative to the first diaphragm, the ratio between the area of the second diaphragm and the area of the first diaphragm may be no less than 0.5. In some embodiments, when the second diaphragm is disposed obliquely relative to the first diaphragm, the ratio between the outer diameter of the second diaphragm and the diameter of the first diaphragm may be not less than 1. In some embodiments, when the second diaphragm is disposed obliquely relative to the first diaphragm, the ratio between the outer diameter of the second diaphragm and the diameter of the first diaphragm may be not less than 0.8. In some embodiments, when the second diaphragm is disposed obliquely relative to the first diaphragm, the ratio between the outer diameter of the second diaphragm and the diameter of the first diaphragm may be not less than 0.5.

In some embodiments, the acoustic output device 1000, when in use, needs to output a low-to-medium frequency signal that is large enough to ensure an output volume of the acoustic output device 1000. For example, when the acoustic output device 1000 is applied in a wearable device and a user wears the wearable device, a low-to-medium frequency signal that is large enough is needed to meet the user's listening volume. On the one hand, the acoustic output device 1000 needs to have a sufficiently large volume output in a low-to-medium frequency range because a human ear is less sensitive to a sound leakage of a signal in the low-to-medium frequency range. On the other hand, since the human ear is more sensitive to a signal in a medium-to-high frequency range, the acoustic output device 1000 needs to achieve a directionality of an acoustic field in the medium-to-high frequency range, so as to reduce the sound leakage of the acoustic output device 1000. A frequency-dividing system may be provided in the acoustic output device 1000 to realize the construction of a directional acoustic field of the acoustic output device 1000 in different frequency ranges. For example, the acoustic output device 1000 may form a directional acoustic field in some frequency ranges (e.g., the medium-to-high frequency range), while not constructing a directional acoustic field in other frequency ranges (e.g., a low-to-medium frequency range). Or, the acoustic output device 1000 may construct a directional acoustic field that is more directional in some frequency ranges (e.g., the medium-to-high frequency range) and less directional in other frequency ranges (e.g., the low-to-medium frequency range).

In some embodiments, the acoustic output device 1000 may include a filtering processing assembly 1030. The filtering processing assembly 1030 may be used to filter an audio signal to generate a first audio signal. Further, the filtering processing assembly 1030 may also perform a phase-modulation processing on the first audio signal to determine a phase-modulated first audio signal. In some embodiments, the first diaphragm of the first acoustic assembly 1010 may generate the first sound based on the audio signal, and the second diaphragm of the second acoustic assembly 1020 may generate the second sound based on the phased-modulated first audio signal. Taking the first audio signal as a medium-to-high frequency signal as an example, the second sound is mainly focused on the medium-to-high frequency range, and the first sound includes not only a medium-to-high frequency sound but also a low frequency sound. In the medium-to-high frequency range, the second sound interferes with the first sound, and the second sound modulates the first sound, thereby constructing the directional acoustic field in the medium-to-high frequency range.

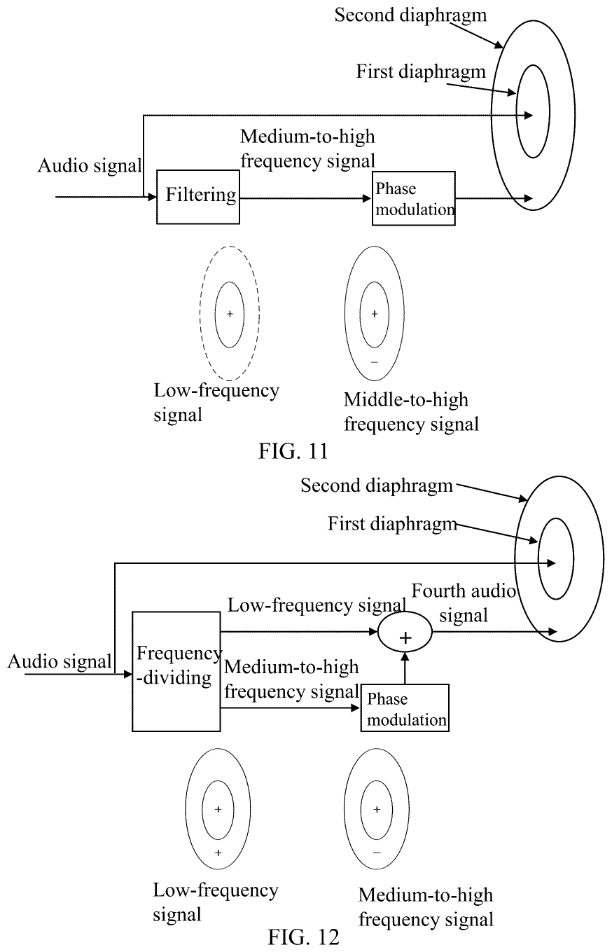

FIG. 11 is a schematic diagram illustrating an exemplary principle of filtering control according to some embodiments of the present disclosure. Referring to FIG. 11, in some embodiments, the acoustic output device 1000 receives an audio signal, and a first diaphragm may vibrate to produce a first sound based on the audio signal. Meanwhile, the filtering processing assembly 1030 may filter the audio signal to obtain a medium-to-high frequency signal, which may be used as a frequency signal component for realizing the directivity of the acoustic output device 1000. Further, the filtering processing assembly 1030 performs a phase-modulation processing on the medium-to-high frequency signal obtained by filtering. For example, the phase-modulation processing may include a phase-inverting processing. In some embodiments, the phase-inverting processing refers to that a phase difference between a phase of the medium-to-high frequency signal before processing and a phase of the medium-to-high frequency signal after processing is within a specific range. For example, the phase-inverting processing may be that the phase difference between the phase of the medium-to-high frequency signal before processing and the phase of the medium-to-high frequency signal after processing is in a range of 150 degrees to 210 degrees. The second diaphragm vibrates based on the phase-modulated medium-to-high frequency signal to produce a second sound. A phase of the second sound is opposite or approximately opposite to a phase of the medium-to-high frequency signal in the first sound. The second sound interferes with the medium-to-high frequency signal in the first sound, thereby constructing a directional acoustic field in the medium-to-high frequency range, and improving the directivity of the acoustic output device 1000 in the medium-to-high frequency range.

In some embodiments, by providing the filtering processing assembly 1030 in the acoustic output device 1000, the construction of a directional acoustic field in a target frequency range (e.g., the medium-to-high frequency range) may be realized, henceforth improving a directivity of the acoustic output device 1000 directivity in the target frequency range. It should be noted that the directional acoustic field constructed in the medium-to-high frequency range as described above is only an exemplary description, and in some embodiments, a directional acoustic field in an arbitrary frequency range may be constructed following a method or principle described above. In some embodiments, the acoustic output device 1000 may also not be provided with the filtering processing assembly 1030.

In some embodiments, the acoustic output device 1000 may further include a frequency-dividing processing assembly 1040. The frequency-dividing processing assembly 1040 may be used to divide the audio signal to generate signals of different frequency ranges, for example, a second audio signal and a third audio signal. In some embodiments, the frequency-dividing processing assembly 1040 may divide the audio signal based on a frequency-dividing point to generate signals of different frequency ranges. In some embodiments, a frequency range of the audio signal may be 20 Hz-20 kHz, and a frequency range of the frequency-dividing point may be 200 Hz-1000 Hz. For example, a frequency of the frequency-dividing point is 200 Hz, and correspondingly, a frequency range of the second audio signal may be 20 Hz-200 Hz and a frequency range of the third audio signal may be 200 Hz-20 kHz. As another example, the frequency of the frequency-dividing point may be 500 Hz, and correspondingly, the frequency range of the second audio signal may be 20 Hz-500 Hz, and the frequency range of the third audio signal may be 500 Hz-20 kHz. For ease of description, the following description takes the second audio signal including a low frequency signal and the third audio signal including a medium-to-high frequency signal as an example. In some embodiments, a frequency range of a low frequency signal obtained by dividing the frequency by the frequency-dividing processing assembly 1040 may be 20 Hz-500 Hz. In some embodiments, a frequency range of a medium-to-high frequency signal obtained by dividing the frequency by the frequency processing assembly 1040 may be 500 Hz-9000 Hz.

In some embodiments, the frequency-dividing processing assembly 1040 may also perform a phase-modulation processing on the medium-to-high frequency signal obtained after the frequency-dividing to determine a phase-modulated medium-to-high frequency signal. In some embodiments, the phase-modulation processing of the frequency-dividing processing assembly 1040 may include a phase-inverting processing. The phase-inverting processing refers to that a phase difference between a phase of the medium-to-high frequency signal after frequency-dividing and a phase of the phase-modulated medium-to-high frequency signal is within a specific range. For example, the phase-inverting processing may be that the phase difference between the phase of the medium-to-high frequency signal after the frequency-dividing and the phase of the phase-modulated medium-to-high frequency signal is in a range of 150 degrees to 210 degrees. As another example, the phase of the medium-to-high frequency signal obtained after the frequency-dividing and the phase of the phase-modulated medium-to-high frequency signal may be opposite, i.e., the phase difference is 180 degrees.

In some embodiments, both sides of the first diaphragm (or the second diaphragm) included in the first acoustic assembly 1010 (or the second acoustic assembly 1020) of the acoustic output device 1000 radiate sounds outward. Phases of the sounds radiated from both sides of the first diaphragm (or the second diaphragm) are opposite to each other, which constructs an acoustic field with a certain directivity in a space, for example, a quasi-dipole acoustic field. In some embodiments, due to the impact of the acoustic output device 1000, other acoustic structures, and boundary conditions, the directional acoustic field may only be constructed in a particular frequency band (e.g., a low frequency range), and the construction of the directional acoustic field is limited in other frequency bands (e.g., a medium-to-high frequency range). Therefore, the construction of a directional acoustic field in the medium-to-high frequency range may be constructed by frequency-dividing performed by the frequency-dividing processing assembly 1040, which obtains a low-frequency signal and a medium-to-high frequency signal and inverts a phase of the medium-to-high frequency signal, thereby constructing the directional acoustic field in the medium-to-high frequency range.

In some embodiments, the frequency-dividing processing assembly 1040 may be used to determine a fourth audio signal based on the low frequency signal and the phase-modulated medium-to-high frequency signal, and the second diaphragm of the second acoustic assembly 1020 may generate the second sound based on the fourth audio signal. The first diaphragm of the first acoustic assembly 1010 may generate the first sound based on an initial audio signal.

FIG. 12 is a schematic diagram illustrating an exemplary principle of frequency-dividing control according to some embodiments of the present disclosure. Referring to FIG. 12, in some embodiments, an audio signal may drive a first diaphragm to vibrate to produce a first sound. Meanwhile, the frequency-dividing processing assembly 1040 may perform a frequency-dividing processing on the audio signal to obtain a low frequency signal and a medium-to-high frequency signal. The frequency-dividing processing assembly 1040 may further perform a phase-modulation processing (e.g., a phase-inverting processing) on the medium-to-high frequency signal. The phase-modulated medium-to-high frequency signal is synthesized with the low frequency signal obtained by the frequency-dividing processing, thereby obtaining a fourth audio signal. The fourth audio signal may drive a second diaphragm to vibrate to produce a second sound. In some embodiments, a phase of the low frequency signal in the fourth audio signal is the same as a phase of an audio signal that drives the first diaphragm (i.e., an initial audio signal that has not been processed by frequency-dividing and phase-modulation), a phase of a medium-to-high frequency signal in the fourth audio signal is opposite to the phase of the audio signals that drives the first diaphragm. In such cases, the second sound may modulate the first sound, thereby improving the directivity of the acoustic output device 1000.

In some embodiments, the first sound or the second sound may be radiated outwardly from one side of the first diaphragm or the second diaphragm, and a third sound may be radiated from the other side of the first diaphragm or the second diaphragm. Further, the acoustic output device may construct a quasi-dipole acoustic field as described above based on the first sound or the second sound, and the third sound. For example, the acoustic output device 1000 may include a housing for accommodating the first acoustic assembly 1010 and the second acoustic assembly 1020. The housing may include a sound guiding hole for directing the sound generated on the other side of the first diaphragm or the second diaphragm. The sound guided by the sound guiding hole may be noted as the third sound. In some embodiments, the third sound may be opposite in phase to the first sound or the second sound. In some embodiments, the third sound may interfere with the first sound or the second sound, thereby constructing a directional acoustic field in different frequency bands and improving the directivity of the acoustic output device 1000. For example, a position of the sound guiding hole on the housing may be set such that the third sound may minimize a degree of phase cancellation with the first sound or the second sound at a target position (e.g., a human ear), thereby enhancing a volume at the target position. As another example, the sound guiding hole may be set on the housing such that the third sound may interfere with the first sound or the second sound in a far-field by phase cancellation, thereby decreasing a volume of sound leakage in the far-field. For example, a distance between the sound guiding hole and the first diaphragm or the second diaphragm may be set so that the third sound produced by the sound guiding hole is equal in amplitude (or approximately equal) and opposite in phase (or approximately opposite) to that of the first sound, thereby reducing the volume of the sound leakage in the far-field.

It should be noted that a frequency-dividing manner shown in FIG. 12 not only realizes the construction of a directional acoustic field in a medium-to-high-frequency range, but also may be used for constructing a directional acoustic field in a specific frequency band, and the present disclosure does not make any limitation herein.

In some embodiments, two acoustic output devices may also be utilized to construct a directional acoustic field according to different mechanisms, thereby enabling the construction of a directional acoustic field in a wide frequency range. In some embodiments, the frequency-dividing processing assembly 1040 may divide the audio signal to obtain a low frequency signal and a medium-to-high frequency signal, and the first diaphragm of the acoustic output device 1000 may generate the first sound based on a medium-to-high frequency signal obtained after frequency-dividing. The frequency-dividing processing assembly 1040 may further perform a phase-modulation processing on the medium-to-high frequency signal after frequency-dividing, and the second diaphragm may generate the second sound based on a phase-modulated medium-to-high frequency signal. The first sound and the second sound are in opposite phase. In some embodiments, the acoustic output device 1000 may further comprise a second acoustic output device, the second acoustic output device may comprise a third acoustic component, and the third acoustic component may comprise a third diaphragm. The third diaphragm may generate a fourth sound based on the low frequency signal after frequency-dividing. In some embodiments, both sides of the third diaphragm may radiate a sound outward. Further, the second acoustic output device may construct a quasi-dipole acoustic field based on sounds radiated from both sides of the third diaphragm. For example, the fourth sound generated by the third diaphragm based on the low frequency signal after frequency-dividing may be radiated outwardly from one side of the third diaphragm. The second acoustic output device may also include a second housing, the second housing being configured to accommodate the third acoustic component. The second housing may comprise a second sound guiding hole for guiding a sound generated on the other side of the third diaphragm. The sound guided by the second sound guiding hole may be noted as a fifth sound. The fifth sound and the fourth sound are in opposite phases.

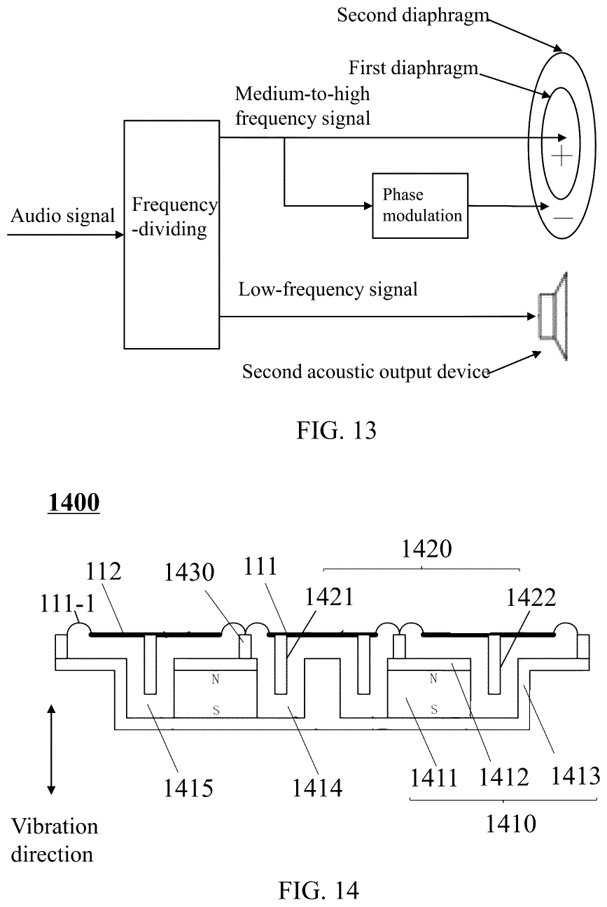

FIG. 13 is a schematic diagram illustrating another exemplary principle of frequency-dividing control according to some embodiments of the present disclosure. Referring to FIG. 13, an audio signal may be divided by the frequency-dividing processing assembly 1040 to obtain a low frequency signal and a medium-to-high frequency signal, wherein the low frequency signal is used to drive a diaphragm in a second acoustic output device to vibrate to generate a sound. The sound may be output from one side of the diaphragm in the second acoustic output device and noted as a fourth sound. The sound may also be output from another side of the diaphragm in the second acoustic output device. For example, the second acoustic output device may comprise a second sound guiding hole, and the sound may be guided out of the second sound guiding hole and noted as a fifth sound. The sound guided from the second sound guiding hole (i.e., the fifth sound) may be in opposite phase to the fourth sound, such that the second acoustic output device may construct a quasi-dipole acoustic field in a low frequency range based on the fifth sound and the fourth sound. For example, a position of the second sound guiding hole on the housing may be set such that a degree of phase cancellation between the fourth sound and the fifth sound at a target position may be minimized (e.g., a human ear), thereby enhancing a volume at the target position. For example, the position of the second sound guiding hole on the housing may be set so that the fourth sound may interfere with the fifth sound for phase cancellation at a specific place in a space, thereby enabling the construction of a directional acoustic field in a low frequency range.

In some embodiments, as shown in FIG. 13, the medium-to-high frequency signal obtained from frequency-dividing may drive a first diaphragm of the acoustic output device 1000 to vibrate to produce a first sound. At the same time, a phase-modulation processing may be performed on the medium-to-high frequency signal by the frequency-dividing processing assembly 1040, and a phase-modulated medium-to-high frequency signal may drive a second diaphragm of the acoustic output device 1000 to vibrate to produce a second sound. A phase of the second sound is opposite to a phase of the first sound, and the second sound interferes with the first sound, thereby realizing the construction of a directional acoustic field in a medium-to-high frequency range.

Using the frequency-dividing control manner shown in FIG. 13, a low frequency signal may be obtained by frequency-dividing and the directional acoustic field in the low frequency range may be constructed using an acoustic output device of a small size. Additionally, the directional acoustic field in the medium-to-high frequency range may be constructed by performing a phase-modulation processing on a high-frequency signal obtained by frequency-dividing. As a result, the frequency-dividing control manner shown in FIG. 13 may realize the construction of a directional acoustic field in a wide frequency range. It should be noted that the frequency-dividing control manner shown in FIG. 13 not only realizes the construction of the directional acoustic field in the low frequency range and medium-to-high frequency range, but also may be used to construct a directional acoustic field in a specific frequency range, which is not limited in the present disclosure.

It should be understood that the foregoing description of the acoustic output device 1000 is for illustrative purposes only and is not intended to limit the scope of the present disclosure. For those skilled in the art, various deformations and modifications may be made under the guidance of the present disclosure. These deformations and modifications may fall within the scope of protection of the present disclosure.

In some embodiments, components of the acoustic output device 1000 may be adapted as appropriate. For example, the second acoustic assembly 1020, the filtering processing assembly 1030, and the frequency-dividing processing assembly 1040 may be omitted. The acoustic output device 1000 may include the first acoustic assembly 1010 and a housing. The first acoustic assembly 1010 may include a first diaphragm, and both sides of the first diaphragm may radiate sounds outward. The housing may comprise a sound guiding hole, and the sound guiding hole may be provided around the first diaphragm. For example, in the same manner as or similar to the configuration of the second diaphragm as described above, the sound guiding hole may be an annular sound guiding hole disposed around the first diaphragm. One side of the first diaphragm may radiate a first sound outwardly, and the annular sound guiding hole may be used to guide a second sound generated by the other side of the first diaphragm. In some embodiments, the annular sound guiding hole may be provided to cause the first sound to interfere with the second sound to produce a directional acoustic field pointing to a target direction.

FIG. 14 is a schematic diagram illustrating an exemplary structure of an acoustic output device according to some embodiments of the present disclosure. Referring to FIG. 14, in some embodiments, when a first acoustic assembly and a second acoustic assembly are provided in an acoustic output device 1400, the first acoustic assembly may include a first diaphragm 111, and the first diaphragm 111 vibrates to produce a first sound. The second acoustic assembly may include a second diaphragm 112, and the second diaphragm 112 vibrates to produce a second sound. At least a portion of the second diaphragm 112 is disposed around the first diaphragm 111.

In some embodiments, the acoustic output device 1400 may further include a magnetic circuit assembly 1410 and a voice coil assembly 1420. The magnetic circuit assembly 1410 may include a magnet 1411, a washer 1412, and a U-iron 1413. The U-iron 1413 may be a U-shaped structure, with the magnet 1411 and the washer 1412 disposed inside the U-iron 1413. The washer 1412 and the magnet 1411 are disposed sequentially from top to bottom along a vibration direction of the first diaphragm 111, and the magnet 1411 is connected to a bottom of the U-iron 1413. The washer 1412 is connected to a diaphragm (the first diaphragm 111 and the second diaphragm 112) directly or indirectly to support the diaphragm. For example, the washer 1412 may be connected to the diaphragm (the first diaphragm 111 and the second diaphragm 112) via a frame 1430 to support the diaphragm. In some embodiments, the magnet 1411, the washer 1412, and the U-iron 1413 may form a first magnetic gap 1414 and a second magnetic gap 1415. The second magnetic gap 1415 may be provided around a periphery of the first magnetic gap 1414. Magnetic fields in the first magnetic gap 1414 and the second magnetic gap 1415 are opposite.

The voice coil assembly 1420 may include a first voice coil 1421 and a second voice coil 1422. One end of the first voice coil 1421 is disposed within the first magnetic gap 1414, and the other end of the first voice coil 1421 is connected to the first diaphragm 111. The first diaphragm 111 may be driven by the first voice coil 1421 to vibrate. One end of the second voice coil 1422 is disposed within the second magnetic gap 1415, and the other end of the second voice coil 1422 is connected to the second diaphragm 112. The second diaphragm 112 may be driven by the second voice coil 1422 to vibrate.

In some embodiments, magnetic fields in the first magnetic gap 1414 and the second magnetic gap 1415 are opposite. When an electrical signal of a same phase is passed into the first voice coil 1421 and the second voice coil 1422, directions of a driving force subjected by the first voice coil 1421 and the second voice coil 1422 are opposite, which may cause vibration phases of the first diaphragm 111 and the second diaphragm 112 in response to the first voice coil 1421 and the second voice coil 1422 to be opposite, thereby making phases of the second sound and the first sound opposite. The second sound interferes with the first sound, thereby producing a directional acoustic field pointing to a target direction. In some embodiments, electrical signals with different phase relationships may also be passed into the first voice coil 1421 and the second voice coil 1422, such that the vibration phases of the first diaphragm 111 and the second diaphragm 112 are in different relationships, thereby controlling a directivity of an acoustic field of the acoustic output device 1400. In some embodiments, a phase and/or amplitude of an electrical signal passed into the first voice coil 1421 and the second voice coil 1422 may be adjusted, so as to modulate the vibration phase and/or amplitude of the second diaphragm 112 and the first diaphragm 111, thereby controlling the directivity of the acoustic field of the acoustic output device 1400. For example, the vibration phases of the first diaphragm 111 and the second diaphragm 112 may be adjusted to be the same or similar by adjusting the amplitudes of the electrical signals passed into the first voice coil 1421 and the second voice coil 1422.

In some embodiments, the first diaphragm 111 may be a circular diaphragm, and the second diaphragm 112 may be an annular diaphragm distributed around the circular diaphragm. In some embodiments, the first diaphragm 111 and the second diaphragm 112 may also be other shaped diaphragms. For example, the first diaphragm 111 may be a runway-shaped diaphragm, a rectangular diaphragm, a pentagonal diaphragm, and other regular or irregular-shaped diaphragms, and the second diaphragm 112 may be an annular diaphragm distributed around the runway-shaped diaphragm, a rectangular diaphragm, the pentagonal diaphragm, and other regular or irregularly-shaped diaphragms.

In some embodiments, dimensions of the first diaphragm 111 and the second diaphragm 112 may be reasonably set to improve an output capability and the directivity of the acoustic output device 1400. In some embodiments, a ratio between an outer diameter of the second diaphragm 112 and a diameter of the first diaphragm 111 may be no less than 2. For example, the ratio between the outer diameter of the second diaphragm 112 and the diameter of the first diaphragm 111 may be in a range of 3 to 4. In some embodiments, the ratio between an area of the second diaphragm 112 and an area of the first diaphragm 111 may be no less than 4. For example, the ratio between the area of the second diaphragm 112 and the area of the first diaphragm 111 may be in a range of 9 to 16.

In some embodiments, the first diaphragm 111 and the second diaphragm 112 may be arranged coaxially. The first diaphragm 111 and the second diaphragm 112 being coaxially arranged may facilitate modulation of an acoustic field radiation of the acoustic output device 1400.

In some embodiments, to improve a compliance of the diaphragm (first diaphragm 111, second diaphragm 112), the diaphragm may comprise one or more folding loops 111-1, the folding loops 111-1 projecting outwardly with respect to a surface of the diaphragm. In some embodiments, the folding loops 111-1 may be disposed on a circumferential side of the first diaphragm 111 and/or the second diaphragm 112. The first diaphragm 111 and/or the second diaphragm 112 may be coupled to other structures of the acoustic output device 1400 (e.g., the U-iron 1413, the frame 1430) via the folding loops 111-1. By providing the folding loops 111-1, the compliance of the diaphragm can be improved, thereby improving a low-frequency output capability of the acoustic output device 1400.

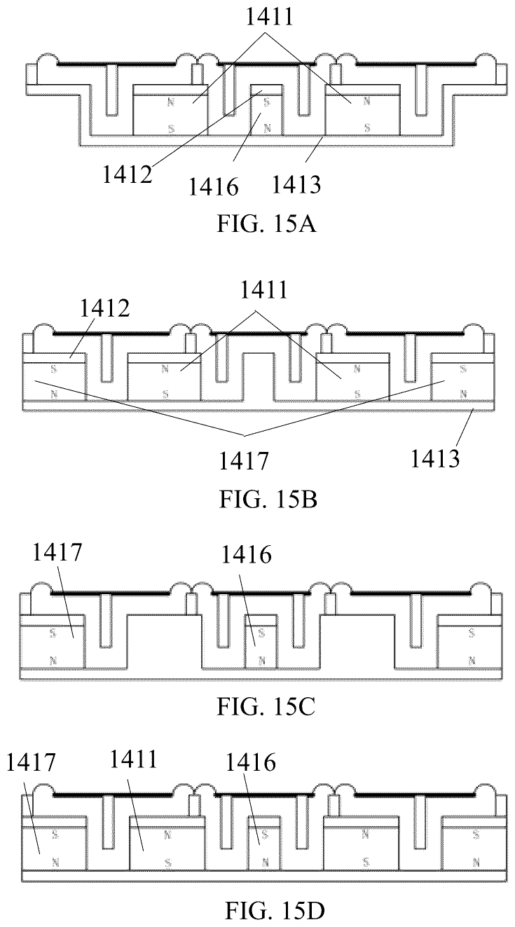

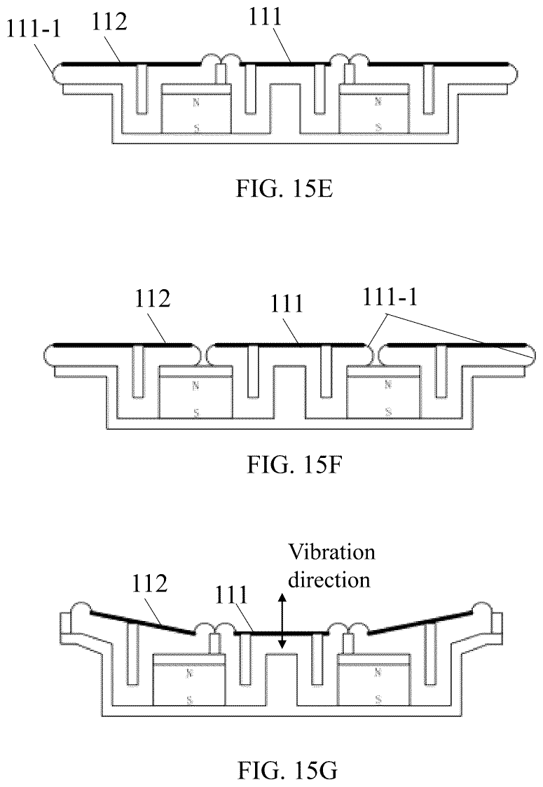

FIGS. 15A to 15D are schematic diagrams illustrating exemplary structures of acoustic output devices according to some embodiments of the present disclosure. In some embodiments, a sensitivity of the acoustic output device 1400 may be increased by adjusting a structure of the magnetic circuit assembly 1410. In some embodiments, the magnetic circuit assembly 1410 may further include a center magnet 1416, as shown in FIG. 15A. The center magnet 1416 is disposed on an inner side of the magnet 1411. One end of the center magnet 1416 is connected to a bottom of the U-iron 1413, and the other end of the center magnet 1416 is connected to the washer 1412. Disposing the center magnet 1416 in the magnetic circuit assembly 1410 may increase a total magnetic flux within the magnetic circuit assembly 1410, thereby increasing a magnetic induction strength of a magnetic gap (e.g., the first magnetic gap 1414) and thereby increasing the sensitivity of the acoustic output device 1400.

Referring to FIG. 15B, the magnetic circuit assembly 1410 may further include an outer magnet 1417. The outer magnet 1417 is disposed on an outer side of the magnet 1411. One end of the outer magnet 1417 is connected to the bottom of the U-iron 1413, and the other end of the outer magnet 1417 is connected to the washer 1412. Disposing the outer magnet 1417 in the magnetic circuit assembly 1410 may increase the total magnetic flux within the magnetic circuit assembly 1410, thereby increasing the magnetic induction strength of the magnetic gap (e.g., the second magnetic gap 1415), and thereby increasing the sensitivity of the acoustic output device 1400.

Referring to FIG. 15C, the magnetic circuit assembly 1410 may include only the center magnet 1416 and the outer magnet 1417 without the magnet 1411. This configuration can also increase the total magnetic flux within the magnetic circuit assembly 1410, thereby increasing the magnetic induction strength of the magnetic gap, which in turn increases the sensitivity of the acoustic output device 1400.

Referring to FIG. 15D, the magnetic circuit assembly 1410 may include three layers of magnets including the center magnet 1416, the magnet 1411, and the outer magnet 1417. A magnetization direction of the magnet 1411 is opposite to the magnetization directions of the center magnet 1416 and the outer magnet 1417. By providing the center magnet 1416, the magnet 1411, and the outer magnet 1417 in the magnetic circuit assembly 1410, the total magnetic flux within the magnetic circuit assembly 1410 may be increased, thereby increasing the magnetic induction strength of the magnetic gap (e.g., the first magnetic gap 1414, second magnetic gap 1415), thereby increasing the sensitivity of the acoustic output device 1400.

FIGS. 15E to 15F are schematic diagrams illustrating exemplary structures of acoustic output devices according to some embodiments of the present disclosure. In some embodiments, a sensitivity and output volume of the acoustic output device 1400 may be increased by adjusting an area of the first diaphragm 111 and/or the second diaphragm 112. In some embodiments, as shown in FIG. 15E, the folding loop 111-1 of the second diaphragm 112 may be disposed on a side of the second diaphragm 112, the folding ring 111-1 projecting outwardly with respect to the side of the second diaphragm 112. This configuration may increase the area of the second diaphragm 112 under the condition that an overall dimension of the acoustic output device 1400 remains unchanged, thereby increasing the sensitivity and output volume of the acoustic output device 1400.

Referring to FIG. 15F, the folding loops 111-1 of the first diaphragm 111 and the second diaphragm 112 may be disposed on a side of the first diaphragm 111 and a side of the second diaphragm 112, so that, under the condition that the overall dimension of the acoustic output device 1400 remains unchanged, the area of the first diaphragm 111 and the area of the second diaphragm 112 increase, thereby increasing the sensitivity and the output volume of the acoustic output device 1400.

In some embodiments, to reduce the dimension of the acoustic output device 1400, and to improve the directivity of the acoustic output device 1400, structures of the second diaphragm 112 and the first diaphragm 111 may be adjusted. FIG. 15G is a schematic diagram illustrating an exemplary structure of an acoustic output device according to some embodiments of the present disclosure. Referring to FIG. 15G, in some embodiments, the second diaphragm 112 may be disposed obliquely relative to the first diaphragm 111. In some embodiments, when the second diaphragm 112 is provided obliquely relative to the first diaphragm 111, along a vibration direction of the first diaphragm 111, an outer edge of the second diaphragm 112 is farther away from the first diaphragm 111 than an inner edge of the second diaphragm 112. The second diaphragm 112 disposed obliquely relative to the first diaphragm 111 may further converge an acoustic beam and improve the directivity of the acoustic output device 1400. At the same time, the overall dimension of the acoustic output device 1400 may be reduced while ensuring a certain dimension of the second diaphragm 112 (e.g., an outer diameter, a width, an area, etc.).

In some embodiments, when the second diaphragm 112 is disposed obliquely relative to the first diaphragm 111, the second diaphragm 112 may be an annular truncated cone structure, and a ratio between an area of the second diaphragm 112 and an area of the first diaphragm 111 may be not less than 1. In some embodiments, when the second diaphragm 112 is disposed relative to the first diaphragm 111 and the second diaphragm 112 is the annular truncated cone structure, a ratio between a diameter of an outer edge of the second diaphragm 112 and a diameter of the first diaphragm 111 may be not less than 1. In some embodiments, when the second diaphragm 112 is disposed obliquely relative to the first diaphragm 111 and the second diaphragm 112 is the annular truncated cone structure, a cone angle of a cone structure corresponding to the annular truncated cone structure may be 45°-180°. In some embodiments, the cone angle of the cone structure corresponding to the annular truncated cone structure may be 90°-160°. In some embodiments, when the second diaphragm 112 is the annular truncated cone structure, the second diaphragm 112 is symmetrically distributed on two sides of the first diaphragm 111. Correspondingly, an angle between a vibration direction of the second diaphragm 112 and the vibration direction of the first diaphragm vibration of the first vibration 111 is reciprocal to one-half of the cone angle. For example, the angle between the vibration direction of the second diaphragm 112 and the vibration direction of the 111 of the first diaphragm vibration may be 0°-67.5° when the cone angle of the cone structure is 45°-180°. As another example, the angle between the vibration direction of the second diaphragm 112 and the vibration direction of the 111 of the first diaphragm vibration may be 0°-45° when the cone angle of the cone structure is 90°-180°.

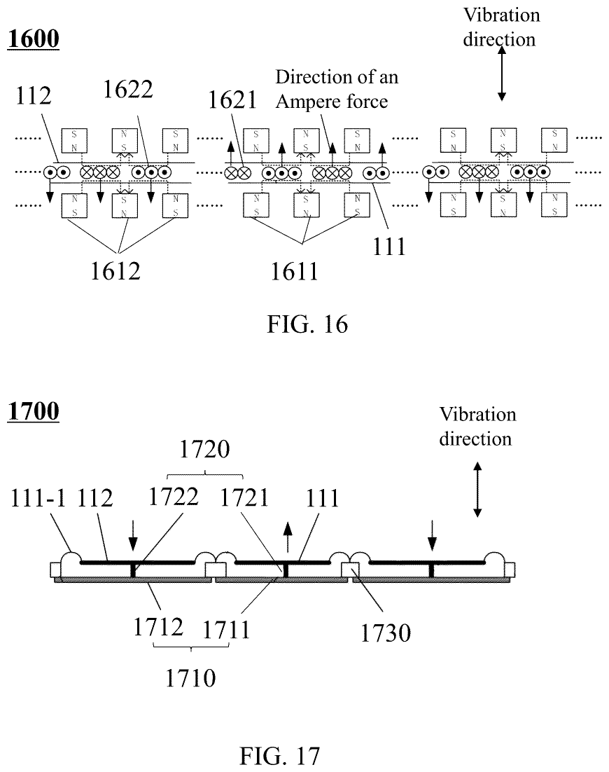

FIG. 16 is a schematic diagram illustrating an exemplary structure of an acoustic output device according to other embodiments of the present disclosure. Referring to FIG. 16, an acoustic output device 1600 may include a first acoustic assembly (the first diaphragm 111), a second acoustic assembly (the second diaphragm 112), a first magnetic circuit assembly, and a second magnetic circuit assembly. The first magnetic circuit assembly may include a plurality of sets of first magnets 1611, the plurality of sets of first magnets 1611 being distributed on two sides of the first diaphragm 111 along the vibration direction of the first diaphragm 111. Magnetization directions of two adjacent first magnets in the plurality of sets of first magnets 1611 are opposite. In some embodiments, each set of first magnets 1611 may include two first magnets with opposite magnetization directions disposed facing each other on both sides of the first diaphragm 111. The first diaphragm 111 is disposed in a magnetic circuit comprising the plurality of sets of first magnets 1611.

The second magnetic circuit assembly may include a plurality of sets of second magnets 1612, the plurality of sets of second magnets 1612 being disposed on two sides of the second diaphragm 112 along the vibration direction of the second diaphragm 112. Magnetization directions of two adjacent second magnets in the plurality of sets of second magnets 1612 are opposite. In some embodiments, each set of second magnets 1612 may include two second magnets with opposite magnetization directions disposed facing each other on two sides of the second diaphragm 112. The second diaphragm 112 is disposed in a magnetic circuit comprising the plurality of sets of second magnets 1612.

In some embodiments, the acoustic output device 1600 may further include a first wire 1621 and a second wire 1622. The first wire 1621 may be disposed within the first diaphragm 111, the first wire 1621 being disposed between two adjacent sets of first magnets 1611. The second wire 1622 may be disposed within the second diaphragm 112, the second lead 1622 being disposed between two adjacent sets of second magnets 1612. In some embodiments, current directions of the first lead 1621 and the second lead 1622 may be set according to directions of magnetic fields where the first lead 1621 and the second lead 1622 are located. In some embodiments, the current directions passed into the first wire 1621 and the second wire 1622 located in a magnetic field with a same direction may be opposite.

In some embodiments, an extension direction of the first wire 1621 is parallel to a diaphragm plane direction of the first diaphragm 111, and an extension direction of the second wire 1622 is parallel to a diaphragm plane direction of the second diaphragm 112. In some embodiments, when a current (an electrical signal) is passed into the first wire 1621 and/or the second wire 1622, the current in the wires may flow in a direction that is parallel to a diaphragm plane direction of a corresponding diaphragm. For example, the current direction in the wires (the first wire 1621 and/or the second wire 1622) may be parallel to the diaphragm plane direction of the diaphragm (the first diaphragm 111 and/or the second diaphragm 112) and be outward (represented in FIG. 16 by a dots), or be parallel to the diaphragm plane direction of the diaphragm (represented by a fork in FIG. 16) and be inward.

In some embodiments, the plurality of sets of magnets provided on two sides of the diaphragm may form a magnetic circuit. Magnetization directions of two adjacent magnets in the plurality of sets of magnets are opposite, which may make a direction of a magnetic field between adjacent magnets parallel to a diaphragm plane and perpendicular to a direction of a current in a corresponding wire. Magnetization directions of two magnets in each set of magnets are opposite. The diaphragm is located in the magnetic circuit formed by the plurality of sets of magnets, and the diaphragm is driven by an Ampere force perpendicular to the diaphragm plane, resulting in a vibration. In some embodiments, a vibration direction (or phase) of a diaphragm corresponding to a wire may be adjusted by adjusting a current direction in the wire and a direction of a magnetic field where the wire is located. In some embodiments, the current direction of the first wire 1621 within the first diaphragm 111 and the current direction of the second wire 1622 within the second diaphragm 112 may be opposite at a location where a direction of a magnetic field is the same, so that an Ampere force subjected by the first diaphragm 111 and an Ampere force subjected by the second diaphragm 112 are opposite, thereby causing vibration phases of the first diaphragm 111 and the second diaphragm 112 to be opposite, thereby causing the first sound to interfere with the second sound, and thereby generating an acoustic field with a directivity.

In some embodiments, the first wire 1621 may be uniformly distributed within the first diaphragm 111, and the second wire 1622 may be uniformly distributed within the second diaphragm 112. This configuration can make a driving force at each position of the first diaphragm 111 and the second diaphragm 112 more uniform, thereby ensuring that a vibration at each position of the first diaphragm 111 and the second diaphragm 112 is more consistent, avoiding a vibration splitting of the first diaphragm 111 and the second diaphragm 112. Disposing the first wire 1621 and the second wire 1622 within the first diaphragm 111 and the second diaphragm 112 enables a second sound generated by the vibration of the second diaphragm 112 to modulate a first sound generated by the first diaphragm 111, thereby realizing construction of a directional acoustic field of the acoustic output device 1600. At the same time, this structural configuration may make the driving force applied to the first diaphragm 111 and the second diaphragm 112 at various positions more uniform, so that the vibration splitting is less likely to occur (e.g., during a high-frequency vibration), and which may broaden a frequency range of a high-frequency response of the acoustic output device 1600, thereby improving the ability of the acoustic output device 1600 to construct a directional acoustic field in a high frequency range.

In some embodiments, the first diaphragm 111 may be a circular diaphragm, and the second diaphragm 112 may be an annular diaphragm around the circular diaphragm. In some embodiments, the first diaphragm 111 and the second diaphragm 112 may be of a one-piece design, at this time, the first diaphragm 111 and the second diaphragm 112 may be differentiated based on how the wires within the diaphragm fit into a magnetic circuit.

In some embodiments, dimensions of the first diaphragm 111 and the second diaphragm 112 may be reasonably set to improve the directivity of the acoustic output device 1600. Taking the first diaphragm 111 being a circular diaphragm and the second diaphragm 112 being an annular diaphragm as an example, in some embodiments, a ratio between an outer diameter of the second diaphragm 112 and a diameter of the first diaphragm 111 may be not less than 2. In some embodiments, the ratio between the outer diameter of the second diaphragm 112 and the diameter of the first diaphragm 111 may be in a range of 3 to 4. In some embodiments, a ratio between an area of the second diaphragm 112 and an area of the first diaphragm 111 may be no less than 4. In some embodiments, the ratio between the area of the second diaphragm 112 and the area of the first diaphragm 111 may be in a range of 9 to 16.

In some embodiments, the first diaphragm 111 and the second diaphragm 112 may be arranged coaxially. The first diaphragm 111 and the second diaphragm 112 being coaxially arranged may facilitate modulation of a radiation of the acoustic output device 1600.

FIG. 17 is a schematic diagram illustrating an exemplary structure of an acoustic output device according to some other embodiments of the present disclosure. Referring to FIG. 17, in some embodiments, an acoustic output device 1700 may include a first acoustic assembly (the first diaphragm 111), a second acoustic assembly (the second diaphragm 112), a piezoelectric assembly 1710, and a vibration transmission assembly 1720. In some embodiments, the piezoelectric assembly 1710 may be composed of a material having a piezoelectric effect such as a piezoelectric ceramic, a piezoelectric polymer, or the like. The piezoelectric assembly 1710 may be used to convert a voltage signal into a mechanical vibration. In some embodiments, the piezoelectric assembly 1710 may be deformed (e.g., a bend deformation) when a voltage is applied to the piezoelectric assembly 1710. When an alternating voltage is applied to the piezoelectric assembly 1710, the piezoelectric assembly 1710 may generate a vibration in a form of reciprocal deformations, thereby converting the voltage signal into the mechanical vibration. In some embodiments, the piezoelectric assembly 1710 is in a state of vibration when at least one end of the piezoelectric assembly 1710 is fixed. For example, when both ends of the piezoelectric assembly 1710 are fixed, vibration amplitudes at end positions of the piezoelectric assembly 1710 are small (or even negligible), and a vibration amplitude at a center position of the piezoelectric assembly 1710 is largest. Accordingly, when two ends of the piezoelectric assembly 1710 are fixed, the center position of the piezoelectric assembly 1710 may be used as a vibration output position to drive other structures (e.g., a diaphragm) of the acoustic output device 1700 to vibrate. As another example, when one end of the piezoelectric assembly 1710 is fixed, a vibration amplitude of a fixed end of the piezoelectric assembly 1710 is small (or even negligible), and a vibration amplitude of the other end of the piezoelectric assembly 1710 is largest. Thus, when one end of the piezoelectric assembly 1710 is fixed, the other end of the piezoelectric assembly 1710 may be used as the vibration output position to drive other structures (e.g., the diaphragm) of the acoustic output device 1700 to vibrate.

In some embodiments, the piezoelectric assembly 1710 may include a first piezoelectric element 1711 and a second piezoelectric element 1712. The second piezoelectric element 1712 may be disposed around the first piezoelectric element 1711. The first piezoelectric element 1711 is disposed in correspondence with the first diaphragm 111 along a vibration direction of the first diaphragm 111. Edges on both sides of the first piezoelectric element 1711 are fixedly connected to a frame 1730. The first piezoelectric element 1711 may be coupled to the first diaphragm 111 via the frame 1730. For example, a peripheral side of the first piezoelectric element 1711 may be connected to the folding loop 111-1 of the first diaphragm 111 via the frame 1730. The second piezoelectric element 1712 is disposed in correspondence with the second diaphragm 112 along a vibration direction of the second diaphragm 112. Edges on two sides of the second piezoelectric element 1712 are fixedly connected to the frame 1730. The second piezoelectric element 1712 may be coupled to the second diaphragm 112 via the frame 1730. For example, a peripheral side of the second piezoelectric element 1712 may be coupled to the folding loop 111-1 of the second diaphragm 112 via the frame 1730. In some embodiments, the first diaphragm 111 and/or the second diaphragm 112 are connected to the frame 1730 via the folding loop 111-1, which may increase compliances of the first diaphragm 111 and/or the second diaphragm 112 while reducing mechanical loads of the first piezoelectric element 1711 and/or the second piezoelectric element 1712 and increasing vibration amplitudes of the first diaphragm 111 and/or the second diaphragm 112, thereby increasing an output capability of the acoustic output device 1700.

In some embodiments, the vibration transmission assembly 1720 may include a first vibration transmission element 1721 and a second vibration transmission element 1722. The first vibration transmission element 1721 is used to connect the first piezoelectric element 1711 and the first diaphragm 111 to transmit the mechanical vibration. When the first piezoelectric element 1711 vibrates, a vibration may be transmitted to the first diaphragm 111 via the first vibration transmission element 1721 to drive the first diaphragm 111 to vibrate. In some embodiments, the first vibration transmission element 1721 may be coupled to a center position of the first piezoelectric element 1711 (e.g., when two ends of the first piezoelectric element 1711 are fixed), so that a vibration of the first piezoelectric element 1711 may be maximally transmitted to the first diaphragm 111. The second vibration transmission element 1722 is used to connect the second piezoelectric element 1712 and the second diaphragm 112 for transmitting the mechanical vibration. When the second piezoelectric element 1712 vibrates, a vibration may be transmitted to the second diaphragm 112 via the second vibration transmission element 1722 to drive the second diaphragm 112 to vibrate. In some embodiments, the second vibration transmission element 1722 may be coupled to a center position of the second piezoelectric element 1712 such that the vibration of the second piezoelectric element 1712 may be maximally transmitted to the second diaphragm 112.

In some embodiments, a vibration direction (or a vibration phase) of the first piezoelectric element 1711 may be made to be opposite to a vibration direction (or a vibration phase) of the second piezoelectric element 1712 in a particular manner, thereby making a vibration direction (or a vibration phase) of the first diaphragm 111 1711 driven by the first piezoelectric element 1711 is opposite to a vibration direction (or a vibration phase) of the second diaphragm 112 driven by the second piezoelectric element 1712, thereby realizing construction of a directional acoustic field of the acoustic output device 1700. In some embodiments, the particular manner may include but is not limited to, a polarization direction of the first piezoelectric element 1711 being opposite to a polarization direction of the second piezoelectric element 1712, electrodes of the first piezoelectric element 1711 and the second piezoelectric element 1712 being set in opposite directions, phases of voltage signals acting on the first piezoelectric element 1711 and the second piezoelectric element 1712 being opposite, or the like.

In some embodiments, the dimensions of the first diaphragm 111 and the second diaphragm 112 may be reasonably set to improve the directivity of the acoustic output device 1700. Taking the first diaphragm 111 being a circular diaphragm and the second diaphragm 112 being an annular diaphragm as an example, in some embodiments, a ratio between an outer diameter of the second diaphragm 112 and a diameter of the first diaphragm 111 may be not less than 2. For example, the ratio between the outer diameter of the second diaphragm 112 and the diameter of the first diaphragm 111 may be in a range of 3 to 4. In some embodiments, the ratio between an area of the second diaphragm 112 and an area of the first diaphragm 111 may be no less than 4. For example, the ratio between the area of the second diaphragm 112 and the area of the first diaphragm 111 may be in a range of 9 to 16.

In some embodiments, the first diaphragm 111 and the second diaphragm 112 may be arranged coaxially. The first diaphragm 111 and the second diaphragm 112 being coaxially arranged may facilitate modulation of a radiation of the acoustic output device 1700.

In some embodiments, the piezoelectric assembly 1710 may be fixed on one end. When one end (also called a fixed end) of the piezoelectric assembly 1710 is fixed and the piezoelectric assembly 1710 is in a state of vibration, a vibration amplitude at the fixed end of the piezoelectric assembly 1710 is small (or even negligible), and the piezoelectric assembly 1710 has a maximum vibration amplitude at the other end (also called a free end). As such, when one end of the piezoelectric assembly 1710 is fixed, the free end of the piezoelectric assembly 1710 may be used as a vibration output position to drive other structures (e.g., the diaphragm) of the acoustic output device 1700 to vibrate.

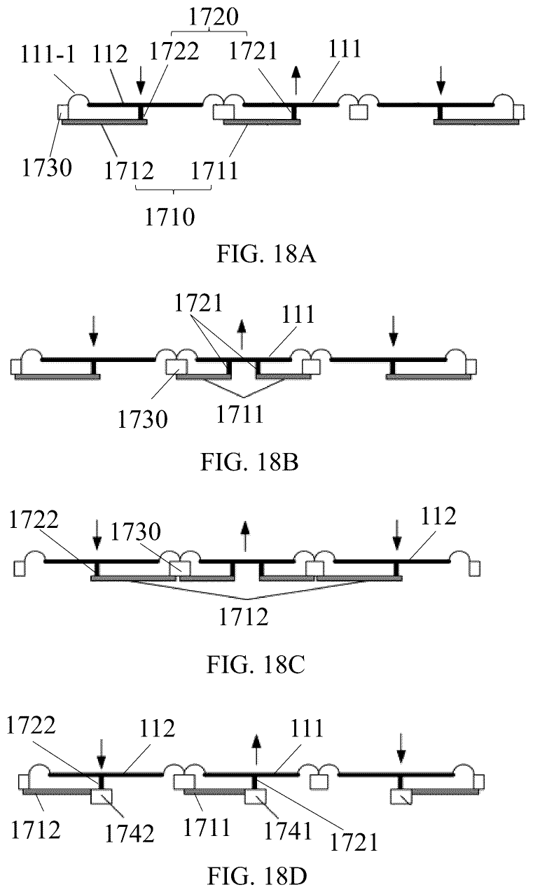

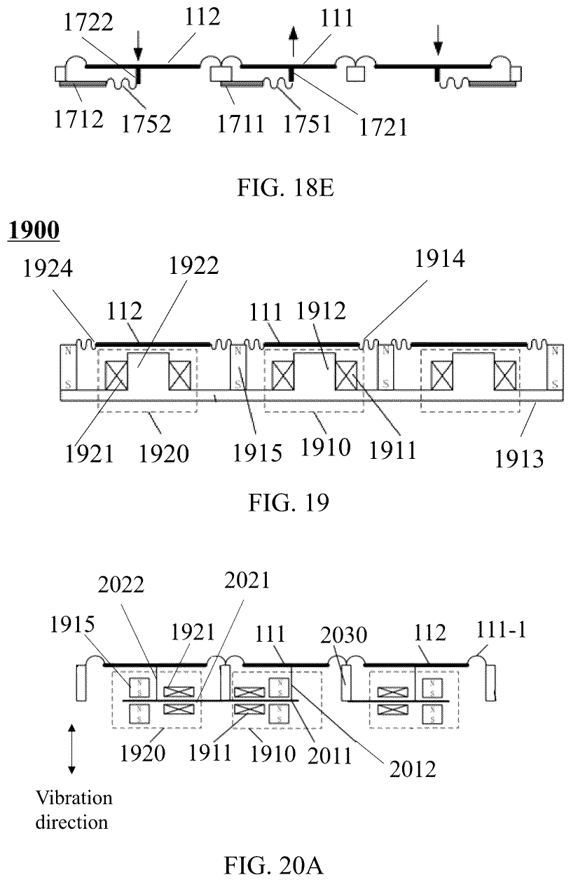

FIG. 18A is a schematic diagram illustrating another exemplary structure of an acoustic output device according to some embodiments of the present disclosure. Referring to FIG. 18A, a fixed end of the first piezoelectric element 1711 is coupled to the frame 1730, and a free end of the first piezoelectric element 1711 or a position near the free end is connected to the first diaphragm 111 via the first vibration transmission element 1721. When the first piezoelectric element 1711 vibrates, a vibration may be transmitted to the first diaphragm 111 via the first vibration transmission element 1721 to drive the first diaphragm 111 to vibrate. In some embodiments, when the first vibration transmission element 1721 is connected to the first piezoelectric element 1711 or a position near the free end of the first piezoelectric element 1711, the vibration of the first piezoelectric element 1711 may be maximally transmitted to the first diaphragm 111.

A fixed end of the second piezoelectric element 1712 is connected to the frame 1730, and a free end of the second piezoelectric element 1712 or a position near the free end is connected to the second diaphragm 112 via the second vibration transmission element 1722. When the second piezoelectric element 1712 vibrates, the vibration may be transmitted to the second diaphragm 112 via the second vibration transmission element 1722 to drive the second diaphragm 112 to vibrate. In some embodiments, when the second vibration transmission element 1722 is connected to the free end of the second piezoelectric element 1712 or a position near the free end, the vibration of the second piezoelectric element 1712 may be maximally transmitted to the second diaphragm 112.

In some embodiments, the sensitivity of the acoustic output device 1700 may be increased by adjusting a count of the first piezoelectric elements 1711 and/or the second piezoelectric elements 1712. FIGS. 18B to 18C are schematic diagrams illustrating exemplary structures of acoustic output devices according to some embodiments of the present disclosure. Referring to FIG. 18B, a count of the first piezoelectric elements 1711 may exceed one. Taking two first piezoelectric elements 1711 as an example, fixed ends of the two first piezoelectric elements 1711 are both fixedly connected to the frame 1730, and free ends are connected to the first diaphragm 111 via a corresponding first vibration transmission element 1721, respectively. Vibrations of the two first piezoelectric elements 1711 may be transmitted to the first diaphragm 111 via the first vibration transmission elements 1721. In some embodiments, the two first piezoelectric elements 1711 may be symmetrically disposed so that the first diaphragm 111 is driven more uniformly, which in turn makes the first diaphragm 111 vibrate more stably. In some embodiments, providing a plurality of the first piezoelectric elements 1711 in the acoustic output device 1700 may increase the driving ability of the first piezoelectric elements 1711 on the first diaphragm 111, thereby increasing the sensitivity of the acoustic output device 1700.

Referring to FIG. 18C, a count of the second piezoelectric elements 1712 may exceed one. Taking two second piezoelectric elements 1712 as an example, fixed ends of the two second piezoelectric elements 1712 are both fixedly connected to the frame 1730, and free ends are connected to the second diaphragm 112 via a corresponding second vibration transmission element 1722, respectively. Vibrations of the two second piezoelectric elements 1712 may be transmitted to the second diaphragm 112 via the second vibration transmission elements 1722. In some embodiments, the two second piezoelectric elements 1712 may be symmetrically disposed so that the second diaphragm 112 is driven more uniformly, which in turn makes the second diaphragm 112 vibrate more stably. In some embodiments, providing a plurality of second piezoelectric elements 1712 in the acoustic output device 1700 may increase the driving ability of the second piezoelectric elements 1712 to the second diaphragm 112, which in turn increases the sensitivity of the acoustic output device 1700.

In some embodiments, a mass element may be provided at or near the free end of the piezoelectric element to improve a low-frequency output capability of the acoustic output device. FIG. 18D is a schematic diagram illustrating an exemplary structure of an acoustic output device according to some embodiments of the present disclosure. Referring to FIG. 18D, a first mass element 1741 may be disposed at or near a free end of the first piezoelectric element 1711, and a second mass element 1742 may be disposed at or near a free end of the second piezoelectric element 1712. The first piezoelectric element 1711 is connected to the first vibration transmission element 1721 via the first mass element 1741. A vibration of the first piezoelectric element 1711 is transmitted to the first diaphragm 111 via the first mass element 1741 and the first vibration transmission element 1721 in turn. The second piezoelectric element 1712 is connected to the second vibration transmission element 1722 via the second mass element 1742. A vibration of the second piezoelectric element 1712 is transmitted to the second diaphragm 112 via the second mass element 1742 and the second vibration transmission element 1722 in turn. Providing a mass element (the first mass element 1741 and/or the second mass element 1742) at or near a free end of a piezoelectric element (the first piezoelectric element a and/or the second piezoelectric element 1712) reduces a resonance frequency of the vibration system of the piezoelectric element, the thereby increasing a low-frequency output capability of an acoustic output device.

In some embodiments, an elastic element is provided between the free end of the piezoelectric element and the vibration transmission element to improve a low-to-medium frequency output capability and sensitivity of the acoustic output device. FIG. 18E is a schematic diagram illustrating an exemplary structure of an acoustic output device according to some embodiments of the present disclosure. Referring to FIG. 18E, a first elastic element 1751 may be provided between a free end of the first piezoelectric element 1711 and the first vibration transmission element 1721, and a second elastic element 1752 may be provided between a free end of the second piezoelectric element 1712 and the second transmission element 1722. The first piezoelectric element 1711 is connected to the first vibration transmission element 1721 via the first elastic element 1751. A vibration of the first piezoelectric element 1711 is transmitted to the first diaphragm 111 via the first elastic element 1751 and the first vibration transmission element 1721 in turn. The second piezoelectric element 1712 is connected to the second vibration transmission element 1722 via the second elastic element 1752. A vibration of the second piezoelectric element 1712 is transmitted to the second diaphragm 112 via the second elastic element 1752 and the second vibration transmission element 1722 in turn. In some embodiments, the first elastic element 1751 and/or the second elastic element 1752 may include, but are not limited to, a metal sheet, a reed, a plastic shrapnel, a spring, a flexible adhesive block, rubber, silicone, or the like. Providing the elastic element between a free end of a piezoelectric element and a vibration transmission element may increase a flexibility of a vibration system of the piezoelectric element, thereby increasing the vibration amplitude of a diaphragm (in particular a vibration amplitude in a low-to-medium frequency band), thereby increasing a sensitivity of the acoustic output device 1700.

FIG. 19 is a schematic diagram illustrating an exemplary structure of an acoustic output device according to other embodiments of the present disclosure. Referring to FIG. 19, an acoustic output device 1900 may comprise a first acoustic assembly (the first diaphragm 111), a second acoustic assembly (the second diaphragm 112), a first magnetic circuit, and a second magnetic circuit. The first magnetic circuit may include a first driving unit 1910, the first driving unit 1910 being provided in correspondence with the first diaphragm 111. The second magnetic circuit may include a second driving unit 1920, the second driving unit 1920 being provided in correspondence with the second diaphragm 112. The second driving unit 1920 is provided around a periphery of the first driving unit 1910. In some embodiments, the first driving unit 1910 may include a first voice coil 1911, the first voice coil 1911 being used to change a magnetic flux density in the first magnetic circuit based on an electrical signal to cause the first diaphragm 111 to vibrate. In some embodiments, the first driving unit 1910 may further include a first iron core 1912, the first iron core 1912 being disposed between a U-iron 1913 and the first diaphragm 111. The first voice coil 1911 is wrapped around the periphery of the first iron core 1912 to form an electromagnet. In some embodiments, a first magnetic conductive layer (e.g., a first reed 1914) may be disposed around a periphery of the first diaphragm 111, and the first magnetic conductive layer, the U-iron 1913, the first iron core 1912, and a magnet 1915 provided between the first driving unit 1910 and the second driving unit 1920 may form the first magnetic circuit. In some embodiments, the first magnetic circuit may be a closed magnetic circuit.

In some embodiments, when an electrical signal is passed into the first voice coil 1911 around the periphery of the first iron core 1912, a magnetic flux density in the first magnetic circuit may be changed such that a distance between the first diaphragm 111 and the first iron core 1912 changes. In some embodiments, when an alternating electrical signal is passed into the first voice coil 1911, a change in the distance between the first diaphragm 111 and the first iron core 1912 is alternating, thereby causing the first diaphragm 111 to vibrate.

The second magnetic circuit may include the second driving unit 1920. In some embodiments, the second driving unit 1920 may include a second voice coil 1921, the second voice coil 1921 being used to change a magnetic flux density in the second magnetic circuit based on an electrical signal to cause the second diaphragm 112 to vibrate. In some embodiments, the second driving unit 1920 may further include a second iron core 1922, the second iron core 1922 being provided between the U-iron 1913 and the second diaphragm 112. The second voice coil 1921 is wrapped around the periphery of the second iron core 1922 to form an electromagnet. In some embodiments, a second magnetic conductive layer (e.g., a second reed 1924) may be provided around a periphery of the second diaphragm 112, and the second magnetic layer, the U-iron 1913, the second iron core 1922, and the magnet 1915 provided between the first driving unit 1910 and the second driving unit 1920 (and an outer side of the second driving unit 1920) may form the second magnetic circuit. In some embodiments, the second magnetic circuit may be a closed magnetic circuit.

In some embodiments, when an electrical signal is passed into the second voice coil 1921 around a periphery of the second iron core 1922, a magnetic flux density in the second magnetic circuit may be changed such that a distance between the second diaphragm 112 and the second iron core 1922 changes. In some embodiments, when an alternating electrical signal is passed into the second voice coil 1921, a change in the distance between the second diaphragm 112 and the second iron core 1922 is alternating, thereby causing the second diaphragm 112 to vibrate.

In some embodiments, a specific manner may be used to cause vibration phases of the first diaphragm 111 and the second diaphragm 112 to be opposite, thereby realizing the construction of a directional acoustic field of the acoustic output device 1900. In some embodiments, the specific manner may include but is not limited to, a winding direction of the first voice coil 1911 being opposite to a winding direction of the second voice coil 1921, a magnetic circuit direction of the first magnetic circuit being opposite to a magnetic circuit direction of the second magnetic circuit, a phase of an electrical signal in the first voice coil 1911 being opposite to a phase of an electrical signal in the second voice coil 1921, or the like.

In some embodiments, by adopting a transducing manner shown in FIG. 19, i.e., by setting the first driving unit 1910 and the second driving unit 1920, sensitivity and a frequency response of the acoustic output device 1900 at a medium-to-high frequency can be improved.

In some embodiments, a shape of the acoustic output device 1900 may include, but is not limited to, regular geometric shapes such as a circle, a rectangle, a square, a runway, a square with rounded corners, or the like, or irregular shapes. In some embodiments, dimensions and shapes of the first diaphragm 111 and the second diaphragm 112 may be reasonably set to improve the directivity of the acoustic output device 1900. In some embodiments, a shape of the first diaphragm 111 may be a runway-shaped diaphragm, a rectangular diaphragm, a pentagonal diaphragm, and other non-circular diaphragms of regular or irregular shapes, and the second diaphragm 112 may be an annular diaphragm distributed around the runway-shaped diaphragm, the rectangular diaphragm, the pentagonal diaphragm, and other non-circular diaphragms of regular or irregular shapes. For example, the first diaphragm 111 may be a rectangular diaphragm, and the second diaphragm 112 is an annular diaphragm distributed around the rectangular diaphragm. In some embodiments, a ratio between an area of the second diaphragm 112 and an area of the first diaphragm 111 may be no less than 4. For example, the ratio between the area of the second diaphragm 112 and the area of the first diaphragm 111 may be in a range of 9 to 16.

In some embodiments, the first diaphragm 111 and the second diaphragm 112 may be arranged coaxially. The first diaphragm 111 and the second diaphragm 112 being coaxially arranged may facilitate modulation of a radiation of the acoustic output device 1900.

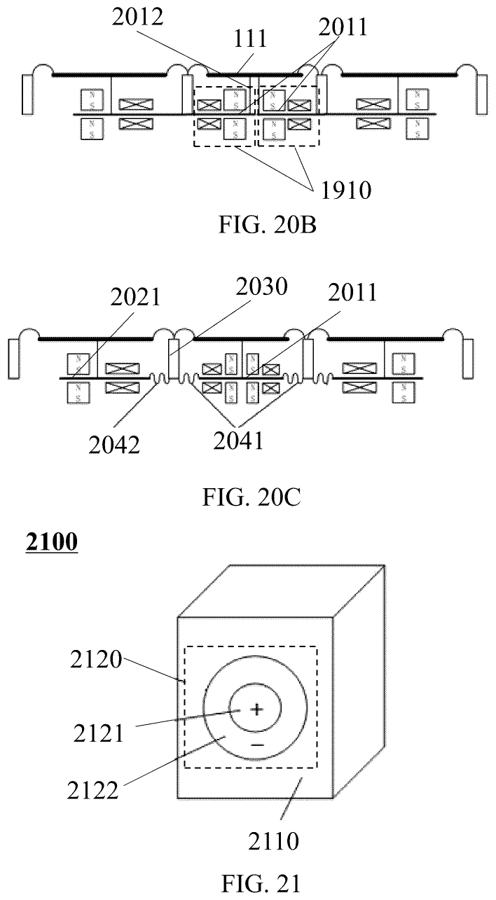

In some embodiments, a driving unit is adjusted to reduce a dimension of the driving unit and increase the sensitivity of the acoustic output device. FIG. 20A is a schematic diagram illustrating an exemplary structure of an acoustic output device according to some embodiments of the present disclosure. Referring to FIG. 20A, in some embodiments, the first driving unit 1910 may include a first armature 2011 and a first vibration transmission member 2012. One end (also called a fixed end) of the first armature 2011 is fixedly connected to a frame 2030, and the other end (also called a free end) or a neighboring position of the first armature 2011 is connected to the first vibration transmission member 2012. The first armature 2011 is disposed suspended relative to the first diaphragm 111. The first armature 2011 is connected to the first diaphragm 111 via the first vibration transmission member 2012 and transmits a vibration signal to the first diaphragm 111. In some embodiments, the fixed end of the first armature 2011 is fixedly connected to the frame 2030 such that the free end of the first armature 2011 may generate a sufficiently large vibration.

In some embodiments, the first driving unit 1910 may not include a first iron core. The first magnetic circuit may be formed by providing two magnets 1915 on two sides of the first armature 2011 along a vibration direction of the first diaphragm 111. In some embodiments, the first voice coil 1911 may comprise two voice coils, the two voice coils being provided on two sides of the first armature 2011. The first voice coil 1911 is disposed side-by-side with the magnet 1915 within the first driving unit 1910. In some embodiments, a magnetic flux density in the first armature 2011 may be changed by passing an alternating electrical signal into the first voice coil 1911, thereby causing the first armature 2011 to generate a vibration corresponding to the electrical signal. A vibration of the first armature 2011 drives the first diaphragm 111 to vibrate via the first vibration transmission member 2012.

In some embodiments, the second driving unit 1920 may further comprise a second armature 2021 and a second vibration transmission member 2022. The second armature 2021 and the second vibration transmission member 2022 of the second driving unit 1920 are configured similarly as the first armature 2011 and the first vibration transmission member 2012, which will not be repeated herein.

In some embodiments, the first diaphragm 111 and/or the second diaphragm 112 and the frame 2030 may be connected through the folding loop 111-1, which may improve the compliance of a diaphragm, thereby increasing the vibration amplitude of the diaphragm, and thereby increasing an output capability of the acoustic output device 1900.

In some embodiments, the sensitivity of the acoustic output device may be improved by providing a plurality of first driving units in an acoustic output device. FIG. 20B is a schematic diagram illustrating an exemplary structure of an acoustic output device according to some embodiments of the present disclosure. Referring to FIG. 20B, a plurality of first driving units 1910 may be disposed side-by-side on one side of the first diaphragm 111. A vibration of the first armature 2011 in each of the plurality of driving units 1910 may drive the first diaphragm 111 to vibrate via the first vibration transmission member 2012. In some embodiments, the plurality of first driving units 1910 may be arranged symmetrically so that the first diaphragm 111 is subjected to a more uniform driving force, thereby improving a vibration stability of the first diaphragm 111. The driving ability of the first driving unit 1910 to the first diaphragm 111 may be improved by providing the plurality of first driving units 1910, thereby improving the sensitivity of the acoustic output device 1900.

FIG. 20C is a schematic diagram illustrating an exemplary structure of an acoustic output device according to some embodiments of the present disclosure. Referring to FIG. 20C, in some embodiments, the acoustic output device 1900 may also include an elastic connector for connecting an armature to a frame. In some embodiments, the acoustic output device 1900 may include a first elastic connector(s) 2041 and a second elastic connector(s) 2042. The first elastic connectors 2041 may be disposed on two sides of the first armature 2011, and the first elastic connectors 2041 may be used to connect the first armature 2011 to the frame 2030. The second elastic connector 2042 may be provided on a side of the second armature 2021 close to the first armature 2011, and the second elastic connector 2042 is used to connect the second armature 2021 to the frame 2030. In some embodiments, a material of the first elastic connector 2041 and/or the second elastic connector 2042 may be a magnetically conductive material including, but not limited to, pure iron, carbon steel, stainless steel, pozzolanic alloy, or the like. In some embodiments, a shape and structure of the first elastic connector 2041 and/or the second elastic connector 2042 may include, but is not limited to, an elastic sheet, a spring, or the like. In some embodiments, the elastic member may be provided to increase a flexibility of an armature, which increases a vibration amplitude of the armature (especially increasing a vibration amplitude in a low-to-medium frequency band), thereby enhancing the sensitivity of an acoustic output device.

FIG. 21 is a schematic diagram illustrating an exemplary structure of a speaker according to some embodiments of the present disclosure. Referring to FIG. 21, a speaker 2100 may include a cabinet 2110 and an acoustic output device 2120. In some embodiments, the cabinet 2110 may be used to carry the acoustic output device 2120 and other components of the speaker 2100. The cabinet 2110 may protect the acoustic output device 2120 and other components of the speaker 2100. In some embodiments, the cabinet 2110 may be a regular or irregular structure such as a square, rectangle, cylinder, sphere, or the like. In some embodiments, the acoustic output device 2120 may be any of the acoustic output devices provided in the embodiments of the present disclosure, for example, the acoustic output device 1000, the acoustic output device 1400, the acoustic output device 1600, the acoustic output device 1700, and the acoustic output device 1900.

In some embodiments, the speaker 2100 may utilize the acoustic output device 2120 to generate a directional acoustic field. In some embodiments, the acoustic output device 2120 may include a first radiation surface 2121 (denoted by “+”) and a second radiation surface 2122 (denoted by “−”). The second radiation surface 2122 surrounds a periphery of the first radiation surface 2121. When the speaker 2100 is operating, by controlling vibration phases (e.g., being opposite) and vibration amplitudes (e.g., being the same or similar) of the first radiation surface 2121 and the second radiation surface 2122, the speaker 2100 may output the directional acoustic field. For example, by setting an acoustic structure of the acoustic output device 2120 (e.g., a driving unit, a magnetic circuit assembly, etc.), the vibration phases of the first diaphragm and the second diaphragm may be opposite such that the vibration phases of the first radiation surface 2121 and the second radiation surface 2122 may be opposite, thereby constructing the directional acoustic field of the speaker 2100.

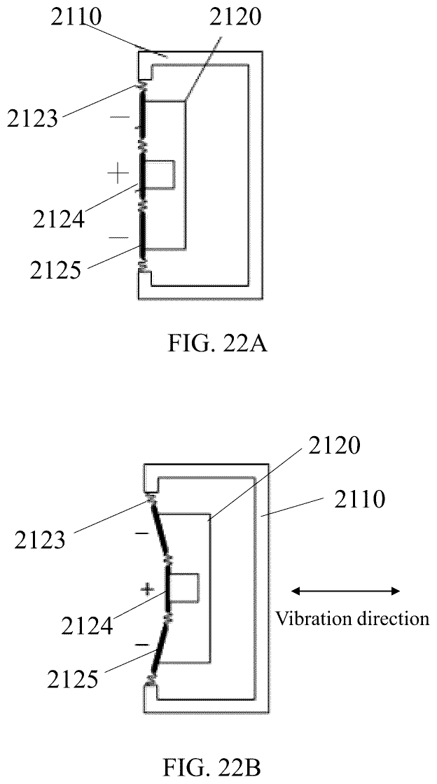

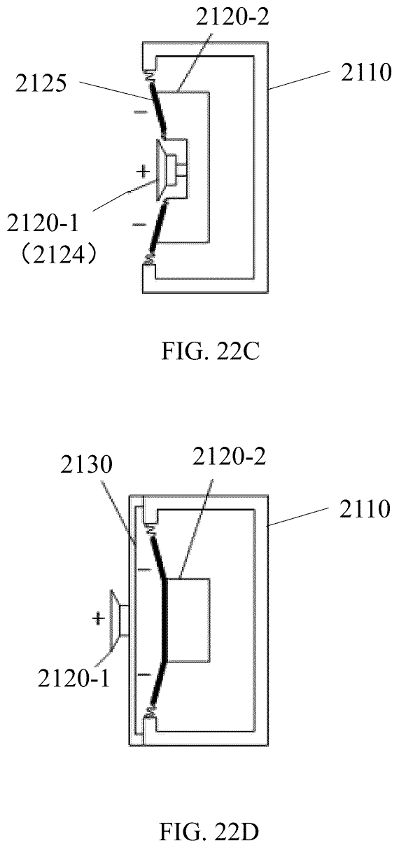

FIGS. 22A to 22D are schematic diagrams illustrating exemplary structures of different driving modes of an acoustic output device of a speaker according to some embodiments of the present disclosure. In conjunction with FIG. 21 and FIG. 22A, the first radiation surface 2121 of the speaker 2100 may be realized by the acoustic output device 2120 driving a first diaphragm 2124 to vibrate, and the second radiation surface 2122 may be realized by the acoustic output device 2120 driving a second diaphragm 2125 to vibrate. The first diaphragm 2124 and the second diaphragm 2125 are provided side-by-side. In some embodiments, the first diaphragm 2124 and the second diaphragm 2125 may be connected by a flexible connector 2123. The second diaphragm 2125 may be connected to the cabinet 2110, or the acoustic output device 2120 may be connected to a relatively fixed position (e.g., a frame) of the cabinet 2110 by the flexible connector 2123. This connection can increase the flexibility of a diaphragm, increase a vibration amplitude of the diaphragm, and thereby increasing the sensitivity of the speaker 2100.

In conjunction with FIG. 21 and FIG. 22B, the first radiation surface 2121 and the second radiation surface 2122 of the speaker 2100 may be realized by the acoustic output device 2120 driving the first diaphragm 2124 and the second diaphragm 2125 to vibrate, respectively. The second diaphragm 2125 may be disposed obliquely relative to the first diaphragm 2124. Along a vibration direction of the first diaphragm 2124, an outer edge of the second diaphragm 2125 is farther away from the first diaphragm 2124 than an inner edge of the second diaphragm 2125. In some embodiments, the first diaphragm 2124 may be located deeper into the cabinet 2110 relative to the second diaphragm 2125. The first diaphragm 2124 disposed more deeply into the cabinet 2110 with respect to the second diaphragm 2125 may reduce a dimension of the acoustic output device 2120, which also improves the efficiency of the speaker 2100 in constructing a directional acoustic field. In some embodiments, the second diaphragm 2125 may be in an annular truncated cone structure. In some embodiments, a cone angle of a cone structure corresponding to the annular truncated cone structure may be in a range of 45° to 160°. In some embodiments, the cone angle of the cone structure corresponding to the annular truncated cone structure may be in a range of 90° to 160°.

In conjunction with FIGS. 21 and 22C, the first radiation surface 2121 and the second radiation surface 2122 of the speaker 2100 may be realized by different acoustic output devices driving corresponding diaphragms to vibrate, respectively. In some embodiments, a first acoustic output device 2020-1 may include a first diaphragm 2124, and the first radiation surface 2121 may be realized by the first acoustic output device 2120-1 driving the first diaphragm 2124 to vibrate. A second acoustic output device 2120-2 may include a second diaphragm 2125, and the second radiation surface 2122 is realized by the second acoustic output device 2120-2 driving the second diaphragm 2125 to vibrate. When the speaker 2100 is operating, a phase and amplitude of the first acoustic output device 2120-1 (the first diaphragm 2124) and a phase and amplitude of the second acoustic output device 2120-2 (the second diaphragm 2125) may be separately controlled, thereby constructing a directional acoustic field. In some embodiments, the first acoustic output device 2120-1 may be disposed at a center position reserved by the second acoustic output device 2120-2. The first acoustic output device 2120-1 is located closer to an interior of the cabinet 2110 relative to the second acoustic output device 2120-2. This configuration reduces a dimension of the second acoustic output device 2120-2, which also improves the efficiency of the construction of the directional acoustic field.

In conjunction with FIG. 21 and FIG. 22D, the first acoustic output device 2120-1 may be disposed on the speaker 2100 via a bracket 2130. The first acoustic output device 2120-1 and the second acoustic output device 2120-2 may be coaxially arranged. In such cases, the second acoustic output device 2120-2 does not need to reserve a position for placing the first acoustic output device 2120-1, which ensures the integrity of the diaphragm and simplifies the manufacturing process.

Embodiments of the present disclosure also provide an acoustic output system, wherein the acoustic output system may include a first loudspeaker array and a second loudspeaker array. The first loudspeaker array may be used to generate a first sound and the second loudspeaker array may be used to generate a second sound. At least a portion of the second loudspeaker array is provided around the first loudspeaker array. In a target frequency range, phases of the first sound and the second sound are opposite, such that the second sound interferes with the first sound to produce a directional acoustic field pointing to a target direction.

In some embodiments, the first loudspeaker array and/or the second loudspeaker array may include a plurality of acoustic output devices as described in embodiments of the present disclosure, for example, the acoustic output device 1000, the acoustic output device 1400, the acoustic output device 1600, the acoustic output device 1700, and the acoustic output device 1900, or any combination thereof. In some embodiments, the first loudspeaker array and/or the second loudspeaker array may utilize one or more of the acoustic output device(s) to achieve the construction of a directional acoustic field.

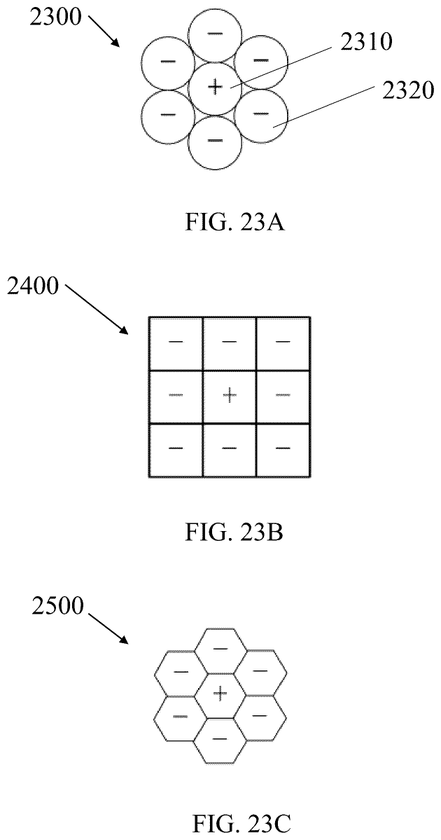

FIG. 23A is a schematic diagram illustrating an exemplary structure of a loudspeaker array according to some other embodiments of the present disclosure. Referring to FIG. 23A, a loudspeaker array 2300 may include a first acoustic output device 2310 and a plurality of second acoustic output devices 2320. The first acoustic output device 2310 may be disposed in a center position of the loudspeaker array 2300, with the plurality of second acoustic output devices 2320 disposed around a periphery of the first acoustic output device 2310. The first acoustic output device 2310 outputs a first sound and the second acoustic output devices 2320 output a second sound. By setting the first acoustic output device 2310 and the second acoustic output device 2320, a phase of the first sound is opposite to a phase of the second sound, and the first sound interferes with the second sound to realize the construction of a directional acoustic field of the loudspeaker array 2300.

In some embodiments, the arrangement manner of individual acoustic output devices in the loudspeaker array 2300 may be different. The directional acoustic field formed by the loudspeaker array 2300 may be controlled by adjusting the arrangement manner of the individual acoustic output devices in the loudspeaker array 2300.

In some embodiments, a shape of the acoustic output device included in the loudspeaker array may have a regular shape such as a circle (as shown in FIG. 23A), a runway shape, a rectangle, a pentagon, a hexagon, or the like, or an irregular shape. As shown in FIG. 23B, an acoustic output device in a loudspeaker array 2400 may be square. Compared to the acoustic output devices having the shape of circles in FIG. 23A, the square acoustic output devices are more tightly connected to each other (which may be approximated as seamless), which may improve a space utilization of the loudspeaker array 2400. As another example, FIG. 23C is a schematic diagram illustrating an exemplary structure of a loudspeaker array according to some embodiments of the present disclosure. As shown in FIG. 23C, an acoustic output device in a loudspeaker array 2500 may be polygonal. Taking the acoustic output devices being hexagonal as an example, compared to the square acoustic output devices in FIG. 23B, the speaker array 2500 may use fewer hexagonal acoustic output devices to achieve a tight connection (approximated as seamless) between acoustic output devices. When the acoustic output devices are hexagonal, a count of acoustic output devices forming the loudspeaker array 2500 may be reduced, which also improves a space utilization of the loudspeaker array 2500.

In some embodiments, when the first acoustic output device is of a same dimension as that of the second acoustic output device disposed outside, a distance between a center of the second acoustic output device and a center of the first acoustic output device is the same, which may make an acoustic field generated by individual second acoustic output device has a comparable controlling effect on an acoustic field generated by the first acoustic output device, thereby increasing a utilization of individual second acoustic output device.

It should be noted that in some embodiments, a count of first acoustic output devices in a loudspeaker array may be one or more, and a count of second acoustic output devices may also be one or more. In some embodiments, a plurality of loudspeaker arrays may also be utilized to achieve a loaded acoustic field directivity.

The basic concepts have been described above, and it is apparent to those skilled in the art that the foregoing detailed disclosure is intended as an example only and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. Such as “an embodiment”, “one embodiment”, and/or “some embodiments” means a feature, structure, or characteristic associated with at least one embodiment of the present disclosure. Accordingly, it should be emphasized and noted that “an embodiment”, “one embodiment” or “an alternative embodiment” referred to two or more times in different locations in the present disclosure do not necessarily refer to the same embodiment. In addition, certain features, structures, or characteristics of one or more embodiments of the present disclosure may be suitably combined.

In addition, it will be appreciated by those skilled in the art that aspects of the present disclosure may be illustrated and described by a number of patentable varieties or embodiments, including any new and useful process, machine, product, or combination of substances, or their any new and useful improvement thereof. Correspondingly, aspects of the present disclosure may be performed exclusively by hardware, may be performed exclusively by software (including firmware, resident software, microcode, etc.), or may be performed by a combination of hardware and software. The above hardware or softwares may be referred to as “data block”, “module”, “engine”, “unit”, “component” or “system”. Additionally, aspects of the present disclosure may be manifested as a computer product located in one or more computer-readable media that includes computer-readable program code.

Computer storage media may comprise a propagation data signal with a computer program encoded within it, e.g., on a baseband or as part of a carrier. The propagation signal may have a variety of manifestations, including an electromagnetic form, an optical form, or the like, or suitable combinations thereof. The computer storage medium may be any computer-readable medium, other than a computer-readable storage medium, which may be used by connecting to an instruction-executing system, device, or apparatus for communicating, propagating, or transmitting for use. The program code located on the computer storage medium may be disseminated via any suitable medium, including radio, cable, fiber optic cable, RF, or the like, or a combination of any of the foregoing.

In addition, the order of processing elements and sequences, the use of numerical letters, or the use of other names described herein are not intended to limit the order of the processes and methods of the present disclosure, unless expressly stated in the claims. While some embodiments of the invention that are currently considered useful are discussed in the foregoing disclosure by way of various examples, it is to be understood that such detail serves only an illustrative purpose, and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software-only solution, e.g., an installation on an existing server or mobile device.

Similarly, it should be noted that in order to simplify the presentation of the disclosure of the present disclosure, and thereby aid in the understanding of one or more embodiments of the invention, the foregoing descriptions of embodiments of the present disclosure sometimes group multiple features together in a single embodiment, accompanying drawings, or in a description thereof. However, this method of disclosure does not imply that the objects of the present disclosure require more features than those mentioned in the claims. Rather, claimed subject matter may lie in less than all features of a single foregoing disclosed embodiment.

Some embodiments use numbers to describe the number of components and attributes, and it should be understood that such numbers used in the description of the embodiments are modified in some examples by the modifiers “about”, “approximately”, or “substantially”. Unless otherwise noted, the terms “about,” “approximately,” or “substantially” indicate that a ±20% variation in the stated number is allowed. Correspondingly, in some embodiments, numerical parameters used in the present disclosure and claims are approximations, which can change depending on the desired characteristics of individual embodiments. In some embodiments, the numerical parameters should take into account the specified number of valid digits and use a general digit retention method. While the numerical domains and parameters used to confirm the breadth of their ranges in some embodiments of the present disclosure are approximations, in specific embodiments, such values are set to be as precise as possible within the range of feasibility.

For each patent, patent application, patent application disclosure, and other material cited in the present disclosure, such as articles, books, specification sheets, publications, documents, etc., the entire contents of which are hereby incorporated herein by reference. Except for application history documents that are inconsistent with or create a conflict with the contents of the present disclosure, and except for documents that limit the broadest scope of the claims of the present disclosure (currently or hereafter appended to the present disclosure). It should be noted that in the event of any inconsistency or conflict between the descriptions, definitions, and/or use of terminology in the materials appended to the present disclosure and those set forth in the present disclosure, the descriptions, definitions and/or use of terms in the present disclosure shall prevail.

Finally, it should be understood that the embodiments described in the present disclosure are used only to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

1. An acoustic output device, comprising:
a first acoustic assembly, wherein the first acoustic assembly includes a first diaphragm, and the first diaphragm is configured to vibrate to produce a first sound; and
a second acoustic assembly, wherein the second acoustic assembly includes a second diaphragm, and the second diaphragm is configured to vibrate to produce a second sound, wherein
at least a portion of the second diaphragm is disposed around the first diaphragm; and
in a target frequency range, a vibration phase of the first diaphragm is opposite to a vibration phase of the second diaphragm, and the second sound interferes with the first sound to produce a directional acoustic field pointing to a target direction.

2. The acoustic output device of claim 1, wherein a ratio between a vibration amplitude of the first diaphragm and a vibration amplitude of the second diaphragm is in a range of 0.8 to 1.2.

3. The acoustic output device of claim 1, wherein the first diaphragm is a circular diaphragm, the second diaphragm is an annular diaphragm around the circular diaphragm, and the first diaphragm and the second diaphragm are coaxially arranged.

4. The acoustic output device of claim 3, wherein the first diaphragm and the second diaphragm are disposed side-by-side, and a vibration direction of the second diaphragm is parallel to a vibration direction of the first diaphragm.

5. The acoustic output device of claim 4, wherein a ratio between an outer diameter of the second diaphragm and a diameter of the first diaphragm is not less than 2.

6. The acoustic output device of claim 4, wherein a ratio between an annular width of the second diaphragm and a radius of the first diaphragm is not less than 2.

7. The acoustic output device of claim 4, wherein a ratio between an area of the second diaphragm and an area of the first diaphragm is not less than 4.

8. The acoustic output device of claim 3, wherein the second diaphragm is disposed obliquely relative to the first diaphragm, and an angle between a vibration direction of the second diaphragm and a vibration direction of the first diaphragm is in a range of 0°-45°.

9. The acoustic output device of claim 8, wherein along the vibration direction of the first diaphragm, an outer edge of the second diaphragm is farther away from the first diaphragm than an inner edge of the second diaphragm.

10. The acoustic output device of claim 9, wherein a ratio between an area of the second diaphragm and an area of the first diaphragm is not less than 1.

11. The acoustic output device of claim 9, wherein a ratio between an outer diameter of the second diaphragm and a diameter of the first diaphragm is not less than 1.

12. The acoustic output device of claim 1, further comprising a filtering processing assembly configured to:
generate a first audio signal by performing a filtering processing on an audio signal; and
determine a phase-modulated first audio signal by performing a phase-modulation processing on the first audio signal, wherein the first diaphragm generates the first sound based on the audio signal, and the second diaphragm generates the second sound based on the phase-modulated first audio signal.

13. The acoustic output device of claim 1, further comprising a frequency-dividing processing assembly, configured to:
generate a second audio signal and a third audio signal by dividing an audio signal;
determine a phase-modulated third audio signal by performing a phase-modulation processing on the third audio signal.

14-16. (canceled)

17. The acoustic output device of claim 13, wherein the frequency-dividing processing assembly is further configured to determine a fourth audio signal based on the second audio signal and the phase-modulated third audio signal, wherein the first diaphragm generates the first sound based on the audio signal, and the second diaphragm generates the second sound based on the fourth audio signal.

18. (canceled)

19. The acoustic output device of claim 13, wherein,
the first diaphragm generates the first sound based on the third audio signal; and
the second diaphragm generates the second sound based on the phase-modulated third audio signal.

20. The acoustic output device of claim 19, further comprising a second acoustic output device, wherein the second acoustic output device includes:
a third acoustic assembly, comprising a third diaphragm configured to generate a fourth sound based on the second audio signal, wherein
the acoustic output device further includes a housing for accommodating the third acoustic assembly, wherein the housing comprises a sound quinine hole configured to quid a fifth sound generated by the third diaphragm out of the housing, and the fifth sound and the fourth sound are opposite in phase.

21. (canceled)

22. The acoustic output device of claim 1, further comprising:
a magnetic circuit assembly, configured to provide a first magnetic gap and a second magnetic gap, and a direction of a magnetic field in the first magnetic gap is opposite to a direction of a magnetic field in the second magnetic gap; and
a voice coil assembly, comprising a first voice coil and a second voice coil, wherein
one end of the first voice coil is disposed within the first magnetic gap, and the other end of the first voice coil is connected to the first diaphragm; and
one end of the second voice coil is disposed within the second magnetic gap, and the other end of the second voice coil is connected to the second diaphragm.

23. The acoustic output device of claim 1, further comprising:
a first magnetic circuit assembly, comprising a plurality of sets of first magnets, each set of first magnets comprising two first magnets with opposite magnetization directions, wherein the two first magnets are disposed facing each other on two sides of the first diaphragm;
a second magnetic circuit assembly, comprising a plurality of sets of second magnets, each set of second magnets comprising two second magnets with opposite magnetization directions, wherein the two second magnets are disposed facing each other on two sides of the second diaphragm;
a first wire disposed within the first diaphragm, wherein the first wire is disposed between two adjacent first magnets of the plurality of sets of first magnets; and
a second wire disposed within the second diaphragm, wherein the second wire is disposed between two adjacent second magnets of the plurality of sets of second magnets, wherein
the first wire and the second wire disposed in a same direction of a magnetic field are opposite in current direction.

24. (canceled)

25. (canceled)

26. The acoustic output device of claim 1, further comprising:
a piezoelectric assembly configured to convert a voltage signal into a mechanical vibration, comprising a first piezoelectric element and a second piezoelectric element; and
a vibration transmission assembly, comprising a first vibration transmission element and a second vibration transmission element, wherein
the first vibration transmission element is configured to connect the first piezoelectric element and the first diaphragm to transmit the mechanical vibration; and
the second vibration transmission element is configured to connect the second piezoelectric element and the second diaphragm to transmit the mechanical vibration,
wherein the piezoelectric assembly satisfies a condition including any one of:
the first piezoelectric element and the second piezoelectric element being opposite in polarization direction;
the first piezoelectric element and the second piezoelectric element having opposite electrodes; and
piezoelectric signals acting on the first piezoelectric element and the second piezoelectric element being opposite in phase.

27-29. (canceled)

30. The acoustic output device of claim 1, comprising:
a first magnetic circuit, comprising a first driving unit, wherein the first driving unit comprises a first voice coil configured to cause the first diaphragm to vibrate by changing, based on an electrical signal, a magnetic flux density in the first magnetic circuit; and
a second magnetic circuit, comprising a second driving unit, wherein the second driving unit comprises a second voice coil configured to cause the second diaphragm to vibrate by changing, based on the electrical signal, a magnetic flux density in the second magnetic circuit, wherein the first magnetic circuit and the second magnetic circuit satisfy a condition including any one of:
winding directions of the first voice coil and the second voice coil being opposite;
magnetic circuit directions of the first magnetic circuit and the second magnetic circuit being opposite; and
an electrical signal in the first voice coil and an electrical signal in the second voice coil being opposite in phase.

31-34. (canceled)
